(19) United States
(12) Patent Application Publication
(10) Pub. No.: US 2006/0022910 A1
(43) Pub. Date: Feb. 2, 2006

(54) Multifunction display device

(76) Inventors: Takuro Sekiya, Kanagawa (JP); Koji Hirakura, Kanagawa (JP); Ikuo Shiota, Miyagi (JP); Hiroshi Koide, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/189,902

(22) Filed: Jul. 27, 2005

(30) Foreign Application Priority Data
Jul. 30, 2004 (JP) 2004-224613
Jan. 26, 2005 (JP) 2005-017766
Jan. 27, 2005 (JP) 2005-019754
Jan. 27, 2005 (JP) 2005-019924
Jan. 27, 2005 (JP) 2005-020128
Jan. 31, 2005 (JP) 2005-022394
Jan. 31, 2005 (JP) 2005-022834

(51) Int. Cl. G09G 3/30

(52) U.S. Cl. 345/76

(57) ABSTRACT

In a multifunction display device, a plurality of display units have a sheet-like or plate-like configuration and different displaying capabilities. A holding unit holds the plurality of display units. A power supply unit supplies power to the plurality of display units. In the multifunction display device, the plurality of display units, the holding unit, and the power supply unit are united, and the holding unit allows a display surface of each of the plurality of display units to be freely opened or closed in a rotatable manner.

### BACKGROUND OF THE INVENTION

1. Field of the Invention

The present invention generally relates to a multifunction display device, and more particularly to a multifunction display device in which a plurality of information input/output units are unified.

2. Description of the Related Art

With development of the information society, the conventional method of distributing various kinds of information with newspapers or books is being substituted for by the electronic information method. In the electronic information method, various kinds of information in the electronic form are distributed to various terminals, such as computers or PDAs, and those kinds of information are viewed on display devices. Accordingly, the research and development of the display devices are about to grow.

These display devices may be classified into the emission type display devices which emit light by themselves, and the reflection type display devices which use a reflected light by the external light source, such as interior light or sunlight, for visual recognition of the information.

An example of the former is a CRT display device. In recent years, the CRT display device is going to be substituted for by various slim-structure display devices including a liquid crystal display device with backlight, a plasma display device, and an electron-emission type display device (for example, refer to Japanese Laid-Open Patent Application No. 2000-030605).

Moreover, the new technology which attracts attention as promoting the weight saving, the slim structure and the low-cost volume production and easily eliminating the low contrast, the narrow viewing angle, etc., which are the problems of the liquid crystal display device, is the organic EL display device utilizing organic electro-luminescence (EL) elements. And the research of the materials of the organic EL display device is prosperous (for example, refer to Japanese Laid-Open Patent Application No. 2003-142269).

On the other hand, the reflection type liquid-crystal display device has an attractive feature that the energy consumption thereof is not so high as that of the emission type display device for the use as a display device for portable terminals, although it has the technical subject of the narrow viewing angle. The modified research is succeeding performed for the purpose of increased brightness (for example, refer to Japanese Laid-Open Patent Application No. 05-061027).

Otherwise, the research of the reflection type display device utilizing the electrophoresis of microcapsule particles is also prosperous (for example, refer to Japanese Laid-Open Patent Application No. 2002-520655).

Besides these, various kinds of display techniques, such as a particulate material orientation type display, a coloring particle rotation type display, a PLZT display, a DMD (digital micro mirror device) display, an electro-granular fluid display, a SED (surface-conduction emitter display), etc. are studied.

This is because there is no single technology which fulfills all the demands for high definition, colorization, motion picture display, low energy drive, slim structure, weight saving, flexibility, robustness, paper-like handling, and low-cost production. It is conceivable that, from now on, the display technology will be put in practical use with the optimal technology according to each demand.

On the other hand, apart from the electronic information display technology mentioned above, the paper-based display method used conventionally exhibits the ease of handling and has some attractive feature which is hard to throw away, although it has no diversity as a computer-based information display units like an electronic information display device.

### SUMMARY OF THE INVENTION

A general object of the present invention is to provide a novel and useful multifunction display device in which the above-described problems are eliminated.

A more specific object of the present invention is to provide a multifunction display device which has a new composition that is applicable to various uses and provides multiple display functions effectively in a safe manner.

In order to achieve the above-mentioned objects, the present invention provides a multifunction display device comprising: a plurality of display units having a sheet-like or plate-like configuration and different display capabilities; a holding unit holding the plurality of display units; and a power supply unit supplying power to the plurality of display units, wherein the plurality of display units, the holding unit, and the power supply unit are united, and a display surface of each of the plurality of display units is allowed to be freely opened or closed in a rotatable manner by the holding unit.

According to the present invention, the plurality of display units having a sheet-like or plate-like configuration and different display capabilities, the holding unit, and the power supply unit are united. The display surface of each of the display units is allowed to be freely opened or closed in a rotatable manner by the holding unit. By choosing one of the display units suitably according to the information to be displayed, the optimal display indication can be performed for information to be displayed, and the multifunction display device has a new composition that is applicable to various uses and provides multiple display functions effectively in a safe manner.

The above-described multifunction display device may be configured so that the plurality of display units comprise an electronic display unit and a non-electronic display unit, the non-electronic display unit being smaller in thickness and weight than the electronic display unit.

According to the present invention, in the above-described multifunction display device, the plurality of display units comprise the electronic display unit and the non-electronic display unit which is smaller in thickness and weight than the electronic display unit. The non-electronic display unit which has a slim, lightweight composition allows easy handling of page turning over etc., and it is possible to provide the multifunction display device with good user convenience.

The above-described multifunction display device may be configured so that one of the electronic display unit and the non-electronic display unit is detachable from the multifunction display device.

According to the present invention, in the above-described multifunction display device, the electronic display unit or the non-electronic display unit is detachable from the multifunction display device, and all the display units can be combined, and alternatively either the electronic display unit or the non-electronic display unit can be used. The necessary minimum number of display units in combination can be used in the multifunction display device.

That is, according to the use, a desired combination of the display units is selectable, and it is possible to provide the multifunction display device with good user friendliness. Since weight saving is considered important in the mobile environment to which the present invention is suitably applied, such selective use of the display units allows the multifunction display device of the present invention to provide multiple display functions effectively.

The above-described multifunction display device may be configured so that each of the electronic display unit and the non-electronic display unit has a mounting part connected to the holding unit, and the mounting parts of the electronic display unit and the non-electronic display unit are compatible with each other.

According to the present invention, in the above-described multifunction display device, each of the electronic display unit and the non-electronic display unit has the mounting part connected to the holding unit, and the mounting parts of the electronic display unit and the non-electronic display unit are compatible with each other. It is possible to arbitrarily modify the combination and lamination order of electronic display units and non-electronic display units in the multifunction display device, and it is possible to provide the multifunction display device with good user friendliness.

The above-described multifunction display device may be configured to further comprise an information input unit inputting information used to control information which is displayed on the electronic display unit.

According to the present invention, the above-described multifunction display device is configured to further comprise the information input unit which inputs information used to control the information displayed on the electronic display unit. The display indication can be performed by controlling the displayed information with the information input unit, and it is possible to provide the optimal display indication with respect to the information to be displayed with no redundancy or insufficiency.

The above-described multifunction display device may be configured so that the information input unit is detachable from the multifunction display device.

According to the present invention, in the above-described multifunction display device, the information input unit is detachable from the multifunction display device. When the information input unit is not needed, it can be detached from the multifunction display device, and it is possible to use the multifunction display device in a light-weight state and in a convenient-to-carry manner.

The above-described multifunction display device may be configured so that the information input unit is a keyboard unit.

According to the present invention, in the above-described multifunction display device, the information input unit is the keyboard unit, and it is possible to easily perform the inputting of information.

The above-described multifunction display device may be configured so that the information input unit is a stylusoperated unit.

According to the present invention, in the above-described multifunction display device, the information input unit is the stylusoperated unit, and even when the operator is not good at inputting information with the keyboard, it is possible to easily perform the inputting of the information.

The above-described multifunction display device may be configured so that the information input unit is a scanner unit.

According to the present invention, in the above-described multifunction display device, the information input unit is the scanner unit, and it is possible to easily perform the inputting of two-dimensional image information.

The above-described multifunction display device may be configured so that the information input unit is an image capture unit.

According to the present invention, in the above-described multifunction display device, the information input unit is the image capture unit, and it is possible to easily perform the inputting of 3-dimensional image information.

The above-described multifunction display device may be configured to further comprise a storage unit which is detachably attached to the multifunction display device.

According to the present invention, in the above-described multifunction display device, attachment and detachment of the storage unit is possible, and use of the multifunction display device which needs storage is possible. Since attachment and detachment of the storage unit is possible when needed, the storage unit can be detached from the multifunction display device when storage is not needed, and it is possible to use the multifunction display device in a lighter-weight state and in a convenient-to-carry manner.

The above-described multifunction display device may be configured so that each of the plurality of display units has a flexibility.

According to the present invention, in the above-described multifunction display device, each of the display units is provided to have a flexibility, and it is possible to provide the display units with the features of easy handling at the time of use and easy paging work with increased operability.

The above-described multifunction display device may be configured so that the electronic display unit is provided to display a motion picture.

According to the present invention, in the above-described multifunction display device, the electronic display unit is provided to display a motion picture, and the display indication of video information can also be performed, and it is possible to make the application range of the display units wider.

The above-described multifunction display device may be configured so that the electronic display unit is provided to display a color image.

According to the present invention, in the above-described multifunction display device, the electronic display unit is provided to display a color image, in addition to the above-mentioned effects, and it is possible to make the application range of the display units wider.

The above-described multifunction display device may be configured so that the non-electronic display unit is provided to perform display indication and erasing in a reversible manner.

According to the present invention, in the above-described multifunction display device, the non-electronic display unit is provided to perform display indication and erasing in a reversible manner, and the non-electronic display unit can be repeatedly used, and, in addition to the above-mentioned effects, it is possible to provide the display units with low cost.

The above-described multifunction display device may be configured so that the display indication and erasing is performed in the reversible manner by controlling a thermal energy supplied to a display surface of the non-electronic display unit.

According to the present invention, in the above-described multifunction display device, the thermal energy control given to the display surface is made to perform the display indication and erasing in the reversible manner. By means of a simple device, such as a thermal head, the display indication and erasing can be performed, and it is possible to provide the display units with low cost.

The above-described multifunction display device may be configured so that the display indication and erasing is performed in the reversible manner by controlling a light energy supplied to a display surface of the non-electronic display unit.

According to the present invention, in the above-described multifunction display device, the light energy control given to the display surface is made to perform the display indication and erasing, and it is possible to perform application of energy to the display surface of display indication/erasing in a non-contact manner, and the display surface is not rubbed physically, and it is possible to provide the display units with high durability.

The above-described multifunction display device may be configured so that the non-electronic display unit is a paper having a density of 0.50 g/cm3 or more.

According to the present invention, in the above-described multifunction display device, the non-electronic display unit is a paper having a density of 0.50 g/cm3 or more. Using such paper as the non-electronic display unit, it is possible to secure the strength of a fixed elasticity, and a plurality of sheets of the paper can be bundled. It is possible to easily handle it without sticking when turning over the page. A fixed thickness is also securable, and even when writing down the paper with a ball-point pen, a fountain pen, etc., it is possible to avoid such problems that ink spreads on the back, a character comes floating on the back with writing pressure, and a character transfers by writing pressure on the lower paper.

The above-described multifunction display device may be configured to further comprise: an information input unit inputting information used to control information which is displayed on an electronic display unit among the plurality of display units; and a cover member disposed to hold an outside of the multifunction display device and having a sheet-like or plate-like configuration and a surface which is freely opened or closed in a rotatable manner, wherein the plurality of display units and the information input unit are stacked, and the cover member has outside dimensions larger than dimensions of the plurality of display units and the information input unit.

According to the present invention, the above-described multifunction display device further comprises the information input unit inputting information used to control information which is displayed on the electronic display unit among the plurality of display units, and the cover member disposed to hold the outside of the multifunction display device and having a sheet-like or plate-like configuration and a surface which is freely opened or closed in a rotatable manner, wherein the plurality of display units and the information input unit are stacked, and the cover member has the outside dimensions larger than dimensions of the plurality of display units and the information input unit. Thus, it is possible to protect the multifunction display device from mechanical and physical shocks and it is possible to avoid damaging.

The above-described multifunction display device may be configured so that the cover member is larger in thickness than a non-electronic display unit among the plurality of display units, and formed integrally with the holding unit.

According to the present invention, the cover member in the above-described multifunction display device is larger in thickness that the non-electronic display unit and formed integrally with the holding unit. It is possible to strengthen protection of the multifunction display device from mechanical and physical shocks, and supporting and holding of the non-electronic display unit which is less elastic is possible, and thus the convenience becomes better.

The above-described multifunction display device may be configured so that the cover member has a laminated sheet structure of a plurality of layers containing a shock absorbing layer.

According to the present invention, in the above-described multifunction display device, the cover member has the laminated sheet structure of the plurality of layers containing the shock absorbing layer, and it is possible to strengthen protection of the multifunction display device from mechanical and physical shocks.

The above-described multifunction display device may be configured so that the cover member has a rigidity larger than a rigidity of the plurality of display units.

According to the present invention, in the above-described multifunction display device, the cover member has the rigidity larger than the rigidity of the display units, and protection of the multifunction display device against mechanical and physical shocks can be increased.

The above-described multifunction display device may be configured to further comprise a thickness maintaining unit maintaining a thickness of a region where the plurality of display units are held by the cover member.

According to the present invention, in the above-described multifunction display device, the thickness maintaining unit which maintains the thickness of the region where the plurality of display units are held by the cover member is provided. Even when external pressure is exerted (or, when stacking something, books, etc. on the multifunction display device of the invention), the thickness maintaining unit serves as a stopper or the like which prevents the thickness of the region from being decreased. It is possible to avoid the occurrence of the accident by which the electronic display unit is damaged.

The above-described multifunction display device may be configured so that the cover member is provided to have a shock-absorbing surface which faces the plurality of display units or the information input unit.

According to the present invention, the cover member in the above-described multifunction display device is provided to have a shock-absorbing surface which faces the display units or the information input unit. Even also when external pressure is exerted, it is possible to avoid the occurrence of the accident by which the electronic display unit is damaged.

The above-described multifunction display device may be configured so that the cover member is provided to serve as the power supply unit which supplies power to the electronic display unit.

According to the present invention, the cover member in the above-described multifunction display device serves concurrently as the power supply unit which supplies power to the electronic display unit, and it is possible to realize a multifunction display device having an electric power supply function and a protection function. Electric power can be supplied to each of a plurality of electronic display units from one cover member, and the complicated structure in which the electronic display units are provided with individual power supply units can be eliminated.

The above-described multifunction display device may be configured so that the cover member is made from a sheet polymer battery.

According to the present invention, the cover member in the above-described multifunction display device is constituted from a sheet polymer battery, and not only protection of the multifunction display device but the electric power supply to the electronic display unit can be performed. Since the sheet polymer battery is a polymer battery, it is possible to construct the cover member into a slim, lightweight composition. Furthermore, the cover member can be provided with flexibility, and processing of the sheet polymer battery as the cover member can be realized easily.

The above-described multifunction display device may be configured so that the cover member is made from a solar battery.

According to the present invention, the cover member in the above-described multifunction display device is constituted from the solar battery and not only protection of the multifunction display device but also the electric power supply to the electronic display unit can be performed. Since the solar battery may be a polymer battery, it is possible to construct the cover member into a slim, lightweight composition. Moreover, the cover member can be provided with flexibility, and processing of the solar battery as the cover member can be realized easily.

The above-described multifunction display device may be configured to further comprise a secondary cell which stores electric power generated by the solar battery.

According to the present invention, in the above-described multifunction display device, the secondary cell stores the electric power generated by the solar battery, and the solar battery is irradiated by the natural light, such as daylight, or the artificial light, such as fluorescent light, and the charging of the electric power can be done continuously with the secondary cell. The supplying of the electric power to the electronic display unit is always performed, and a very convenient multifunction display device can be realized.

### BRIEF DESCRIPTION OF THE DRAWINGS

Other objects, features and advantages of the present invention will be apparent from the following detailed description when reading in conjunction with the accompanying drawings.

FIG. 1 is a cross-sectional view of the organic EL element which is applied to the multifunction display device of the invention.

FIG. 2 is a cross-sectional view of the full-color organic EL display element which is applied to the multifunction display device of the invention.

FIG. 3 is a cross-sectional view showing the outline composition of the reflection type liquid-crystal display element which is applied to the multifunction display device of the invention.

FIG. 4 is a diagram showing an example of the optical system which is applied to the reflection-type liquid-crystal display element of FIG. 3.

FIG. 5 is a cross-sectional view of the electrophoresis display element which is applied to the multifunction display device of the invention.

FIG. 6 is a partial cut-away diagram view of the electrode composition of the electrophoresis display element which is applied to the multifunction display device of the invention.

FIG. 7 is a diagram for explaining the principle of operation of a display indication by the electrophoresis microcapsule containing the single-type or coloring particles on the electrophoresis display element.

FIG. 8A and FIG. 8B are diagrams for explaining the principle of operation of a display indication by the electrophoresis microcapsule containing the plural type or coloring particles on the electrophoresis display element.

FIG. 9A and FIG. 9B are diagrams showing the composition of an embodiment of the multifunction display device of the invention.

FIG. 10 is a diagram showing the binder which is applied to the multifunction display device of the invention.

FIG. 11 is a diagram showing the display unit which is applied to the multifunction display device of the invention.

FIG. 12A, FIG. 12B and FIG. 12C are diagrams showing the composition in which the thickness of the peripheral portion is thicker than the display region in the electronic display unit of the invention.

FIG. 13 is a diagram showing an example in which the keyboard as the information input unit is attached to the multifunction display device of the invention.

FIG. 14 is a diagram showing an example in which the memory card as a storage is built in the multifunction display device of the invention.

FIG. 15 is a diagram showing an example in which the optical disk drive as a storage is built in the multifunction display device of the invention.

FIG. 16 is a cross-sectional view showing the composition of an example of the external cover which is applied to the multifunction display device of the invention.

FIG. 17 is a cross-sectional view showing the composition of the polymer electrolyte battery which is applied to the multifunction display device of the invention.

FIG. 18 is a cross-sectional view showing the gel polymer electrolyte holding positive electrode unit in the polymer electrolyte battery.

FIG. 19 is a cross-sectional view showing the gel polymer electrolyte holding negative electrode unit in the polymer electrolyte battery.

FIG. 20 is a cross-sectional view showing the composition of the organic solar cell which is applied to the multifunction display device of the invention.

FIG. 21 is a diagram showing the composition of the storage battery and the organic solar cell which supply electric power to the electronic display unit of the invention.

### DETAILED DESCRIPTION OF PREFERRED EMBODIMENTS

A description will now be given of the preferred embodiments of the invention with reference to the accompanying drawings.

The multifunction display device of the invention is applicable to various uses with a suitable combination of a plurality of various display units and writing media. The display units in combination may include electronic display units which display an image by using electric control, and non-electronic display units which display an image by other control unit, such as heat or light, without using electric control. The present invention is not limited to the illustrated embodiments shown below.

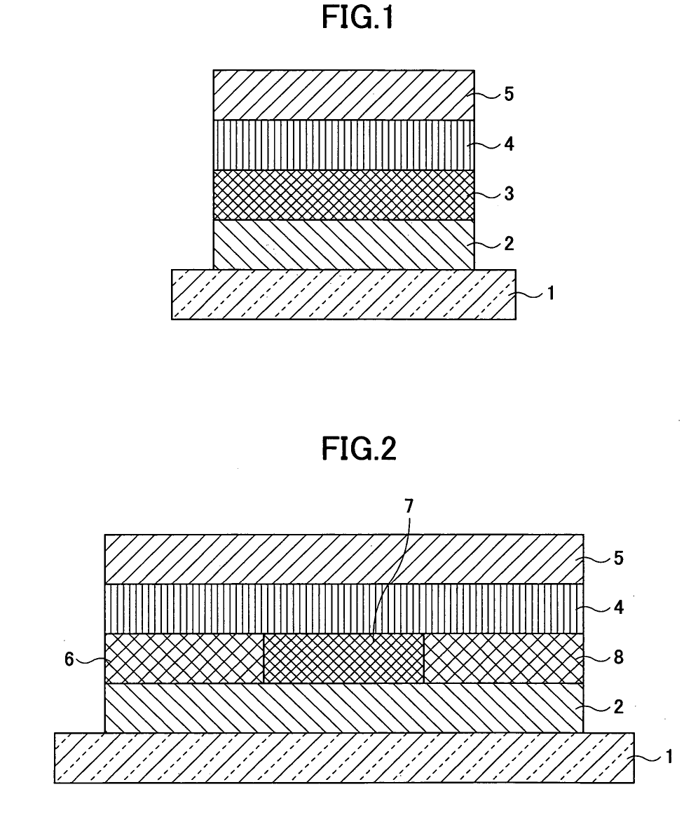

FIG. 1 is a cross-sectional view of the organic EL element which is an example of the electronic display unit applied suitably for the multifunction display device of the invention. The organic EL element has the laminated structure in which the transparent 1st electrode 2, the charge transporting coloring layer 3, the luminescent layer 4, and the 2nd electrode 5 are laminated one by one on the transparent substrate 1.

In this organic EL element, the light emitted from the luminescent layer 4 is taken out through the charge transporting coloring layer 3, the transparent 1st electrode 2, and the transparent substrate 1. The charge transporting coloring layer 3 functions as a light filter, and the emission-spectrum distribution of the light is corrected and the colored light is taken out.

In the organic EL element applied to the invention, the positive hole transporting layer or positive hole injection layer is colored by adding functions of positive hole transportation or positive hole injection to the charge transporting coloring layer. The luminescent layer is used as a white light emission layer. Any luminescent colors can be taken out by combining the white light emission layer with the colored positive hole transporting layer or positive hole injection layer.

In this way, the organic EL element is capable of displaying a color image. In addition, the organic EL element has the advantageous features as follows.

(1) It does not have restriction in the viewing angle and is excellent in visibility since it is a spontaneous light type element.

(2) Unlike LCD, it does not require the backlight, and slim-structure production and miniaturization can be easily attained.

(3) The speed of response is quicker than that of LCD, and it is excellent in a motion picture display.

(4) It hardly produces heat, and the power dissipation is small.

(5) The luminescence cell is made of a solid substance, and a flexible substrate can be used.

By the way, the frame period of the current television set is 30 frames/second, and the motion picture display is performed. In order to view a motion picture with comfort, it is needed that the speed of response of the pixel is 15 milliseconds or less. On the other hand, in the case of the organic EL element, the speed of response of the pixel that is 10 microseconds or less is possible. That is, the organic EL element can be considered the outstanding technology with sufficient performance to perform a comfortable color motion picture display.

FIG. 2 is a cross-sectional view of the full color organic EL display element applied to the invention.

The 1st electrode 2 is formed on the substrate 1, and the red charge transporting coloring layer 6, the green charge transporting coloring layer 7, and the blue charge transporting coloring layer 8 are laminated on the 1st electrode 2. Further, the luminescent layer 4 is laminated on these 3-color charge transporting coloring layers, and the 2nd electrode 5 is laminated on the luminescent layer 4.

By carrying out microscopic arrangement of the charge transporting coloring layers (positive hole transporting layers) of such three (red, green and blue) colors, without needing microscopic arrangement of the luminescent layer or the use of a color filter, microscopic arrangement of red, green and blue luminescence pixels can be carried out so that a full color organic EL display element can be formed.

Of course, microscopic arrangement of the charge transporting coloring layers can also be combined with microscopic arrangement of a luminescent layer and use of a color filter.

The EL layer provided in the organic EL element applied to the invention is an organic layer provided between the 1st electrode and the 2nd electrode which confront each other.

It will not be limited if one-layer EL layer causes electroluminescence at least. Even if directly provided on the 1st electrode, other layers may be made to intervene between the 1st electrode and EL layer if needed, although EL layer is provided on the 1 st electrode (between the 1st electrode and the 2nd electrode).

The EL layer of the invention as a still more indispensable layer as the component as a luminescent layer, the charge transporting coloring layer, and arbitrary layers. The electronic transporting layer which conveys the positive hole transporting layer and electron which convey an positive hole to a luminescent layer. And it may call it a charge transport layer, the electron transporting layer (these may collect and may call it an electric charge pouring layer) which pours an electron into the positive hole transporting layer and luminescent layer, or electronic transporting layer which pours an positive hole into a luminescent layer or an positive hole transporting layer can be provided.

The following are mentioned as a material which constitutes these EL layer. First, the charge transporting coloring layer used for the 1 st by the invention although it is the charge transporting coloring layer is an organic compound layer which has the charge transporting to which optical transmittance becomes large only in a specific wavelength area.

The charge transporting coloring layer used by the invention makes the charge transporting material distribute the dye which has the charge transporting in itself, the dye which comprises paints or does not need to have the charge transporting, and paints, and is constituted. It may have other functions, such as position hole injection and positive hole transportation.

The dye and paint which can be used for the charge transporting coloring layer may include organic coloring matters, such as triphenylmethane dye, xanthine dye, azo dye, metal complexes, such as metal phthalocyanine, metal complex azo, inorganic pigments, such as alpha-Fe2O3, CoO—Al2O3, and semiconductor materials having a value of the band gap in the visible range, such as CdS, CdSSe.

The below-mentioned hole transporting material etc. can be used as the charge transporting material in the case of distributing dye and paints.

When such a material is used, there is no bad influence in luminescence intensity. In order to make the transmissivity other than a selected transmission wavelength region 20% or less, it is preferred that the thickness of the charge transporting coloring layer is in a range of 20 to 2000 nm. It is more desirable that the thickness of the charge transporting coloring layer is in a range of 100 to 500 nm, which is larger than the thickness of the normal transporting layer.

When distributing the charge transporting material and using dye and paints, it is important that it is hard to produce sedimentation and the color change by forming to form salt between dye, and paints and the charge transporting material and an electron donor acceptor complex.

Next, a luminescent layer is a layer which has the function to offer the positive hole and the place of electronic recombination and to make them emit light.

It can have a function in which an electron can be poured in from the cathode or an electron transporting layer, and an electronic transporting layer while being able to pour in an positive hole from an anode plate or an positive hole transporting layer at the time of voltage impression, and a function to which the poured-in electric charge is moved.

The materials which can be used as a material of a luminescent layer may include various metal complexes represented by metal complexes and rare earth complexes, such as oxadiazole derivative, styryl benzene derivative, coumarin derivative, perylene derivative, quinacridone derivative, 8-quinolinol derivative, etc. and high molecular compounds, such as polythiophene derivative, polyphenylene vinylene derivative, polyfluorene derivative, etc. and the mixture thereof.

Next, an positive hole transporting layer is a layer of the function to pour in an positive hole from an anode plate, the function to convey an positive hole, and the function that carries out the barrier of the electron poured in from the cathode which has either at least.

It may divide into the plurality of layers, such as a positive hole transporting layer and an positive hole transporting layer, according to a function.

The materials which constitute the positive hole transporting layer may include a carbazole derivative, positive hole transporting low molecules, such as a triazole derivative, an oxazole derivative, and an oxadiazole derivative, what distributed the positive hole transporting low molecules by using positive hole transporting macromolecules, such as a polyvinylcarbazole derivative and a polythiophene derivative, and macromolecules having no charge transporting layer as the binder, such as polymethylmethacrylate and polystyrene as a binder.

It can use as an positive hole transporting layer colored by distributing the above-mentioned charge transporting coloring layer material.

In the invention, the electrode which provides after that the electrode provided previously on the EL layer the 1st electrode is called as the 2nd electrode.

Although these electrodes in particular are not limited, preferably, an electrode may consist of an anode plate and the cathode and the 1 st electrode may be any of an anode plate and the cathode in this case.

Preferably, it is transparent or translucent in one of an anode plate and the cathodes.

As for an anode plate, what has a larger work function than 4 eV so that it may be easy to pour in an positive hole is preferred. For example, conductive metal oxides, such as tin oxide, zinc oxide, indium oxide and indium oxide tin (ITO), metals, such as gold, silver, chromium and nickel, inorganic conductive substances, such as iodination copper and a sulfide of copper, organic conductive materials, such as polyaniline and polypyrrole, the mixture thereof or the laminated material thereof. And especially, ITO is preferred because of its high conductivity and transparency.

As for the cathode, what has a work function smaller than 4 eV so that it may be easy to pour in an electron is preferred. For example, metal and these alloys, or mixtures, such as alkali metals (for example, lithium, sodium, cesium, etc.) and fluoride of those, alkaline earth metals (calcium, magnesium, etc.) and fluoride of those, aluminum, and silver, etc. are mentioned.

A substrate can be provided in the invention. Although an electrode and EL layer are provided on it and this substrate can consist of transparent material by request, it may be opaque materials.

Although a sheet-like or plate-like thing is used for a substrate, for example, a plastic plate/sheets, such as glass plates, such as quartz and soda glass, a metal plate, a metallic foil, acrylic system resin, styrene resin, and polycarbonate system resin, are used, and a glass and a transparent material like a plastic are desirable.

Since a plastic plate/sheet can do a weight saving, and does not break easily and has flexibility, the operability of the display units is preferred at that which becomes close to paper and adapts itself to a hand easily (the feeling of turning over a page at the time of the change to other display units becomes close to paper) at the time of use.

The manufacturing method of the organic EL element of the invention will not be limited if it is the method that the above-mentioned organic EL element can be manufactured.

The process which specifically provides the 1st electrode on a substrate, for example, and the process which forms red and a green and blue charge transporting coloring layer on this 1st electrode,

The manufacturing method of the organic EL element which comprises a process which forms a white light layer on the red and a green and blue charge transporting coloring layer, and a process which provides the 2nd electrode on the white light layer at least can be used.

By considering it as the manufacturing method by such a procedure, a manufacturing process can be shortened as compared with the conventionally general procedure of providing a light filter, the 1st electrode, an positive hole transporting layer, a white light layer, and the 2nd electrode one by one on the substrate.

Since parallax becomes large, arrangement in the order of a light filter, a substrate, and the 1st electrode is not practical. Since a luminescent layer and the charge transporting coloring layer adjoin, color purity is still better even if compared with the organic EL element which sandwiches the 1st electrode between the conventional light filter and a luminescent layer.

Since formation of the 1st electrode can form on a substrate, without making the middle class with a heat-resistant temperature weak with heat, such as an about 250 degrees C. a maximum of light filter, intervene. There is an advantage in which the 1st electrode can form in at high temperature, therefore the resistance of the 1st electrode falls to about ¼, and conductivity increases and in which the luminous efficiency of an organic EL element is increasing.

Since thick-film formation is possible for the positive hole transporting layer which can be used for the invention, it can use the printing method for formation of an positive hole transporting layer or the charge transporting coloring layer, and simplification and cost reduction of the manufacturing process are possible for it also at this point.

Generally, it is necessary that the luminescent layer of the EL element is made thin and contacting with air is avoided, and patterning is difficult to carry out. According to the invention, patterning of the luminescent layer is not performed and patterning of the charge transporting coloring layer which is easy to pattern is carried out. This is advantageous on the manufacturing process.

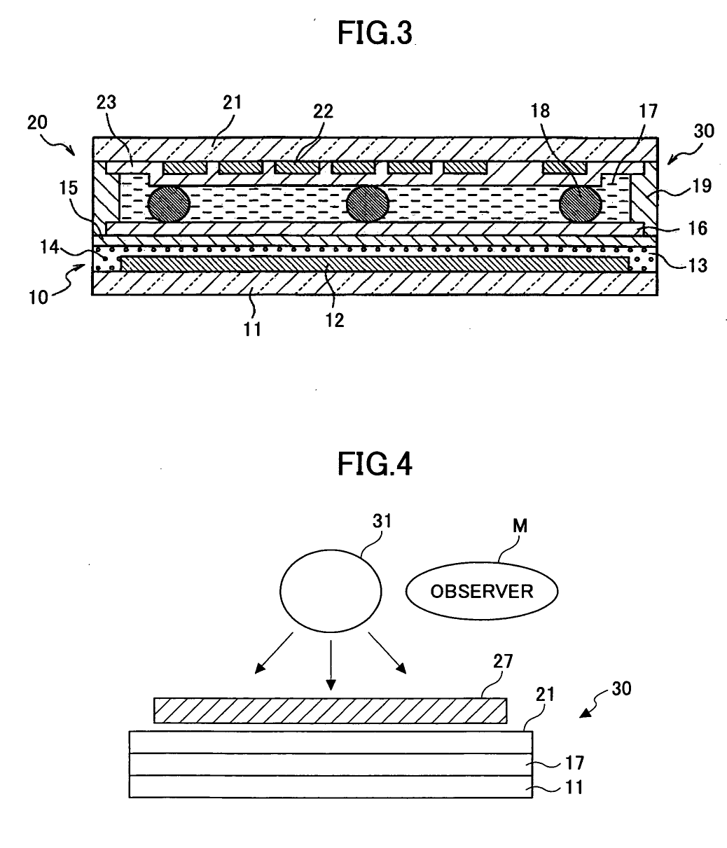

Next, the liquid crystal display element which is an example of the electronic display unit applied suitably for the multifunction display device of the invention will be explained using FIG. 3 and FIG. 4.

Here, the invention is not limited by this although power dissipation explains the embodiment of the reflection type liquid-crystal display element which there are and ends. The reflection type liquid-crystal display element applied suitably for this enforcement. It has a liquid crystal material fastened between the opposite surfaces of a pair of translucency boards countered and arranged, and the translucency board of this 1 pair.

It is a liquid crystal display element which displays using the electro-optical effect which this liquid crystal material has, and has the structure where this order comes to laminate a light reflex layer and the light scattering layer of translucency at one an above-mentioned pair opposite surface side of the translucency boards.

As more concretely shown in FIG. 3, the liquid crystal display element (reflection type liquid-crystal display element) 30, the signal electrode side board 10 which comes in order to form reflective layer (light reflex layer) 12, light scattering layer 13 of translucency, the plurality of signal electrodes (electrode for a liquid crystal drive) 15 arranged in parallel, and liquid crystal orientation film 16 on one surface (opposite surface) of translucency board 11, the scanning electrode side board 20 which comes in order to form the plurality of scanning electrodes (electrode for a liquid crystal drive) 22 and liquid crystal orientation films 23 which are arranged in parallel on one surface (opposite surface) of translucency board 21 has the liquid crystal panel structure by which opposite arrangement is carried out so that it may fasten liquid crystal material 17 by each opposite surface.

The above-mentioned signal electrode 15 and scanning electrode 22 are arranged so that they are perpendicular to each other. The opposite surface of the translucency board means the surface between the liquid crystal material 17 and the opposite surface side of the translucency board 11 (or translucency board 21).

While the A layer and the B layer have the A layer and the B layer are laminated in this order at the opposite surface side, and lamination structure, that the A layer is located near the opposite surface from the B layer.

Therefore, depending on the case, other layers may intervene between the above-mentioned opposite surface and an A layer. This liquid crystal display element 30 is a simple matrix type liquid crystal display element applied to monochrome display, and is a reflection type liquid-crystal display element which displays using the electro-optical effect which impresses predetermined voltage between the intersection parts of the above-mentioned signal electrode 15 and scanning electrode 22, and liquid crystal material 17 has.

In this liquid crystal panel structure, the translucent boards 11 and 21 the opposite surface shall form a liquid crystal cell inside, and shall call it the inside depending on the case, the translucency boards 11 and 21 the trailing side of the inside shall be called the external surface.

Hereafter, the outline of the manufacturing process of the above-mentioned liquid crystal display element 30 will be explained.

The manufacturing process of signal electrode side board 10 which constitutes liquid crystal display element 30 will be explained. The thin film 12 which first comprises material which has high reflective characteristics, such as aluminum, on one surface (opposite surface) of translucency board 11, i.e., a reflective layer, is formed in the homogeneity within a surface by the sputtering method.

Although the layer thickness (thickness) in particular of reflective layer 12 is not limited, it is about 1000 A in this embodiment. The material which makes reflective layer 12 is not limited especially if it has reflective characteristics for which it asks, and it can also use silver etc.

Then, the translucency resin material with which acrylic system resin as a base material comes to distribute granular silica (light scattering particles) 14 with a particle diameter of 2 micrometers almost uniformly is uniformly applied on reflective layer 12 by spin coating.

For example, light scattering layer (translucency resin layer) 13 of 6 micrometers of layer thickness is formed by carrying out ultraviolet curing.

The light scattering layer 13 of this embodiment is formed so that reflective layer 12 may be covered completely as shown in FIG. 3. Although the layer thickness in particular of light scattering layer 13 is not limited, it is more preferred that it is within the limits of 5 micrometers-15 micrometers by the reason for pressing down the surface interior division cloth of the scattering characteristic by thickness distribution, securing plane surface smoothness.

The base material which forms the above-mentioned translucency resin material is not limited especially if it can distribute without having translucency and deteriorating light scattering particles, and it can be used for acrylic system resin for silicone resin, an epoxy resin, etc. by it, replacing with.

However, from a viewpoint that it is possible to form a flat thin film easily (plane surface smoothness is good), acrylic system resin is more preferred.

The above-mentioned base material is a particulate matter which has a different refractive index, light scattering particles 14 are not limited especially if it has the particle diameter below the layer thickness of light scattering layer 13, and a glass bead, a plastic bead, etc. can be used for them.

Then, the above-mentioned light scattering layer 13, ITO (Indium Tin oxide) etc., the transparent electric conduction film which comprises a transparence (translucency) conductive material is formed in the homogeneity within a surface by the sputtering method.

The plurality of signal electrodes 15 each other arranged on abbreviation parallel are formed by patterning this transparent electric conduction film by the photo lithography method.

And pattern formation of the thin film which comprises translucency materials, such as polyimide material, is carried out by the printing method, and liquid crystal orientation film 16 is formed by performing rubbing treatment to this thin film so that this signal electrode 15 may be covered and unevenness may be made flat. In this manner, the signal electrode side board 10 is manufactured.

Next, the outline of the manufacturing process of scanning electrode side board 20 will be explained.

The transparent electric conduction film in which first comes from transparence (translucency) conductive materials, such as ITO (Indium Tin oxide), on one surface (opposite surface) of translucency board 21 is formed in the homogeneity within a surface by the sputtering method.

And the plurality of scanning electrodes 22 each other arranged on abbreviation parallel are formed by patterning this transparent electric conduction film by the photo lithography method.

And pattern formation of the thin film which comprises translucency materials, such as polyimide material, is carried out by the printing method, and liquid crystal orientation film 23 is formed by performing rubbing treatment to this thin film so that this scanning electrode 22 may be covered and unevenness may be made flat.

Then, while liquid crystal orientation films 16 and 23 receive on the other hand (in the case both) and distributing spacer 18, seal resin layer 19 as a binder and a sealing agent is formed in the edge part of signal electrode side board 10 or scanning electrode side board 20.

Seal resin layer 19 is not formed in the portion equivalent to the liquid crystal inlet which is not illustrated. And signal electrode side board 10 and scanning electrode side board 20 are stuck via seal resin 19.

Subsequently, the liquid crystal display element 30 is manufactured by it being poured in and filled up with liquid crystal material 17, and closing a liquid crystal inlet from a liquid crystal inlet, to the inside of a liquid crystal cell.

The above-mentioned spacer 18 functions so that it may hold uniformly the cell gap of the above-mentioned liquid crystal display element 30. It may be the composition that the above-mentioned signal electrode 15 functions as a scanning electrode, and scanning electrode 22 functions as a signal electrode.

As the above-mentioned manufacturing process also explained, reflective layer 12 and light scattering layer 13 are uniformly formed by each planate. Therefore, if it compares with the conventional reflection type liquid-crystal display element (a type liquid crystal display element is called conventionally) which forms a reflective layer (light reflex layer) in accordance with the form on the resin layer which has concavo-convex form, and is made into light scattering and a passive reflector, it is not necessary to provide a flat resin layer for this formation of concavo-convex form flat.

Therefore, it is possible to manufacture efficiently the reflection type liquid-crystal display element provided with the target light scattering and passive reflector (namely, lamination structure board of reflective layer 12 and light scattering layer 13 in this embodiment).

In this embodiment, reflective layer 12 is extremely formed on the translucency board 11 inside by film thickness with 1000 A, and it is thought that it has surface smoothness equivalent to this inside.

Namely, since it is formed on reflective layer 12 which has high surface smoothness, light scattering layer 13 can be formed with surface interior division cloth and the sufficient quality stability distribution between the substrates.

Although the layer thickness of light scattering layer 13 is 6 micrometers in this embodiment, while excelling in the both sides of surface interior division cloth and distribution between substrates, the surface smoothness is also ±0 on the basis of the level surface. Less than 1 micrometer and the extremely excellent value are shown.

It is possible to control an optical loss with this structure, since there is no layer which intervenes between reflective layer 12 and light scattering layer 13. It is possible to manufacture the reflection type liquid-crystal display element which has the extremely excellent optical properties (contrast, a viewing angle, etc.) equivalent to the above-mentioned former type liquid crystal display element with sufficient quality stability.

As shown in FIG. 4, when manufactured liquid crystal display element 30 is applied only to a reflected type, the light used for a display enters in this liquid crystal display element 30 from light source 31 for reflection in the external surface side (the inside of the figure, side in which watcher M is) of translucency board 21.

The film with which this light laminates a polarizing plate and a retardation film, for example. It is given to liquid crystal display element 30 as a light which made it penetrate (polarization retardation film 27 is called hereafter).

The translucency board 21, scanning electrode 22 (a part of light penetrates between scanning electrodes 22.22) which comprises a transparent conductive material, the liquid crystal light distribution film 23, liquid crystal material 17, liquid crystal orientation film 16, signal electrode 15 (a part of light penetrates between signal electrodes 15.15) that comprises a transparent conductive material, and the light scattering layer 13 which is a translucency resin layer is penetrated in order, reflective layer 12 is reached, and it is reflected in the translucency board 21 direction in this reflective layer 12.

The above-mentioned light reflected in reflective layer 12 enters into light scattering layer 13 immediately, by light scattering particles 14 uniformly distributed in this light scattering layer 13, is uniformly diffused inside a liquid crystal cell, and is used for a display.

The light scattering characteristics (optical diffusion characteristics) of light scattering layer 13 are controllable so that it may want for example, by changing elements, such as homoscedasticity degree of light scattering particles 14 in the content; layer thickness; base material of particle diameter; light scattering particles 14 of the combination; light scattering particles of a base material and light scattering particles 14.

What is necessary is to just be arranged between light source 31 for reflection, and liquid crystal display element 30, the above-mentioned polarization retardation film 27 may be stuck on the external surface of translucency board 21, and may be united with liquid crystal display element 30.

By forming polarization retardation film 27, it becomes possible to acquire good display quality under existence of light source 31 for reflection. The light source 31 for reflection in particular that emits the above-mentioned light is not limited, and what is necessary is just to choose it from a natural light source or solar simulators (source of fill light etc.) arbitrarily.

Although a glass substrate is generally used for the reasons of excelling in dimensional stability as translucency boards 11 and 21

When portability is thought as important like the invention and the peculiarity with other display units of using it changing is taken into consideration at the time of use, it is desirable to use a translucency plastic plate (substrate which comprises a translucency plastic material).

Since liquid crystal display element 30 concerning this embodiment is applied suitably for monochrome display as this reason, (1) Control of a dimensional change is which has comparatively few resin layers formed in each of translucency boards 11 and 21 easy, (2) it is only the spatial relationship of the electrodes for a liquid crystal drive (signal electrode 15 and scanning electrode 22), that strict positioning is required has the comparatively large tolerance to a dimensional change, (3) by considering it as flexibility, it is mentioned at the time of change use with other display units that it is easy to adapt itself to the use feeling (feeling which turns over a page) nearer to paper being obtained, i.e., by hand.

In addition, if it changes to a glass substrate and a translucency plastic plate is used, while the slim structure of the reflection type liquid-crystal display element concerning the invention and a weight saving will become possible, there is an advantage, such as being hard to produce breakage of a crack, crazing, etc.

In the invention, even when a translucency plastic plate is actually used as translucency boards 11 and 21, good display quality has been acquired by applying the optical system for a display shown in FIG. 4.

In the invention, the plastic plate if it is a plastic plate which has translucency and flexibility will not be limited. For example, polyethylene terephthalate (PET), polyether sulfone (PES), polyethylenenaphthalate (PEN), polycarbonate (PC), the substrate which comprises nylon, polyetheretherketone (PEEK), polysulfone (PSF), polyether imide (PEI), polyarylate (PAR), poly butylene terephthalate (PBT), or polyimide is pointed out.

Although the speed of response of a liquid crystal display element is the fastest thing, and is about 10 ms and it has a level in which a barely comfortable motion picture display is possible, it is less than the above-mentioned organic EL element.

That is, although the usual motion picture display can be performed satisfactorily, when the request of performing a more nearly high-speed motion picture display comfortably comes out, it is at an advantage in an organic EL element.

However, the liquid crystal display element is advantageous to an organic EL element in respect of low power. In the equipment on condition of carrying like the invention, since there is very little power dissipation in the case of the high reflective liquid crystal which does not use backlight like the above-mentioned explanation in particular, since there is also little battery capacity and it ends, it is convenient.

By the way, when a liquid crystal display element also uses a light filter together, so high-speed a motion picture display is not needed since the color display is possible, but saying that he wants to perform a color display with low power moreover, the liquid crystal display element is advantageous.

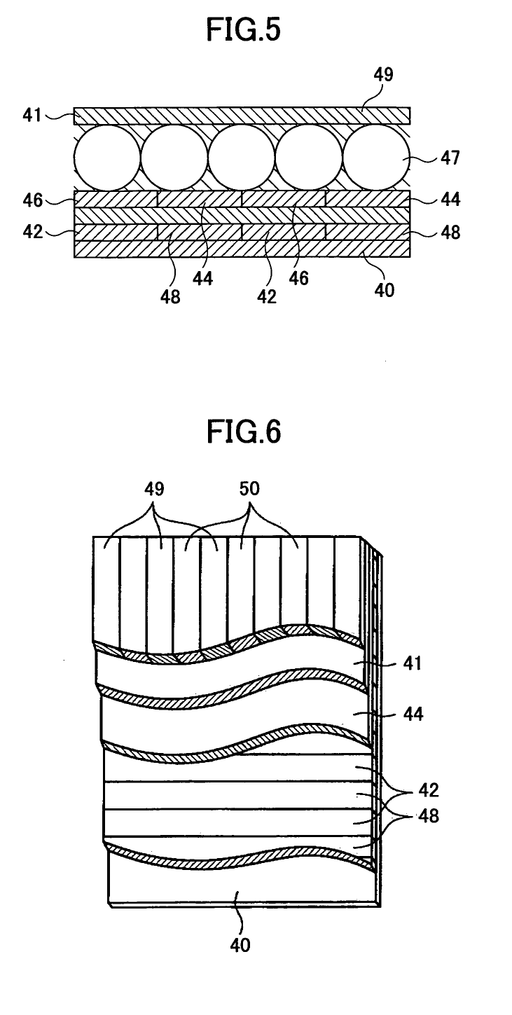

FIG. 5 and FIG. 6 show the composition of a microcapsule type display system as an example of other electronic display units applied suitably for the multifunction display device of the invention.

Generally, a device is provided with substrate 40 which is a thin flexible material like a KAPTON thin film. As for line electrode 42, being covered by the printing process on substrate 40 is preferred.

In the present embodiment, the nonlinear back plane 44 is continuous layers of granular varistor material or granular diode material. The nonlinear back plane 44 can be used as another layer of granular silicon after the layer of granular silicon, and the printed metal point of contact again.

The nonlinear back plane 44 may be made of the layers of the granular semiconductor ink in which the P type and N type which are printed by the pattern which goes to a top like PNPNPNNPNPNP are doped in substitution.

The layer of the number of arbitrary many can be printed and the optimal number is decided mainly depending on desired breakdown voltage. The line electrode 46 (shown only in FIG. 5) by which position doubling is carried out to the 1st group (line electrode) 42 and with which the 2nd group of the option is printed provides the point of contact to the surface of another side of nonlinear material 44.

The printing covering of an insulating material like Acheson ML25208 is carried out at lane 48 which demarcates the space between electrodes 42, and the smooth surface is formed of this.

On the electrode 46, when they are excluded, printing covering of the electrooptic display 41 like the layer of the microcapsule of an electrophoresis type display is carried out at the nonlinear back plane 44 top.

The printing covering of 1 set of transparent sequence electrodes 49 is carried out on display 41 by the pattern which intersects perpendicularly with line electrode 42 (and supposing it is contained 46).

The printing covering of the insulating material is carried out at lane 50 between electrodes 49. An active pixel is demarcated in the domain of display 41, and the group of these electrodes that intersect perpendicularly overlaps it there. Therefore, a display provided with M line electrodes and N sequence electrodes has M×N pixels.

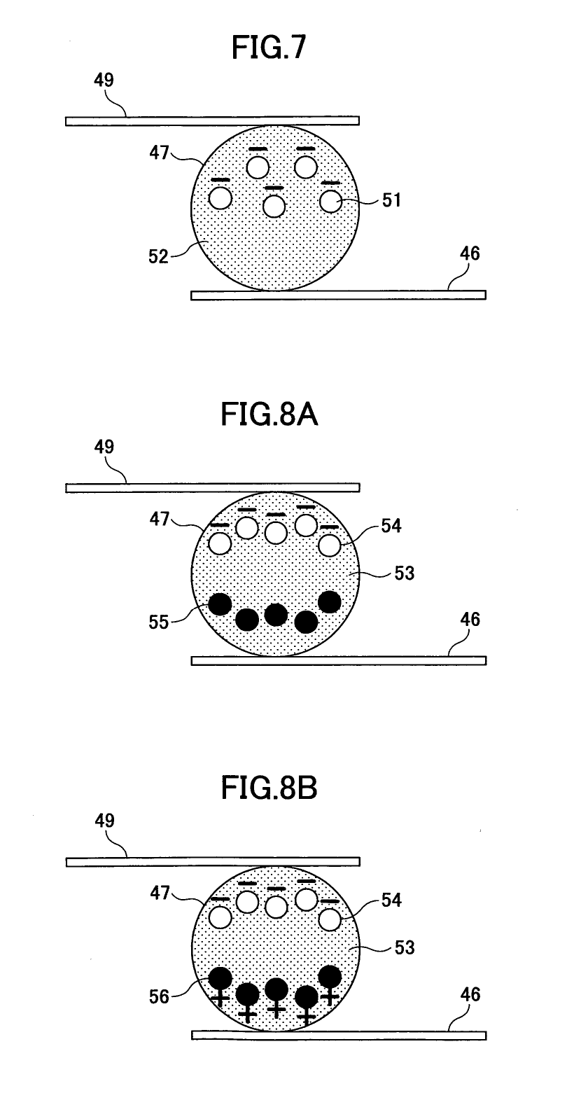

The principle of operation of the display indication by the microcapsule 47 will be explained using FIG. 7, FIG. 8A and FIG. 8B.

Since silicone resin etc. is applied to what is depended on this principle as a binder on the plastic film with which microcapsule 47 has flexibility with an ITO electrode, it is a display units which can pervert freely, page turning over etc. tends to carry out since it adapts itself to a hand well, and is very much easy to treat.

FIG. 7 shows the example of the electrophoresis microcapsule containing the particles of a single type or a color. Many of coloring particles 51 which are enclosed with microcapsule 47 and which have an electric charge including spiropiran and a chelating agent by applying the bias for reverse to the electrodes 46 and 49 alternatively.

In dye addition suspension fluid 52 which comprises oil, migration is caused for the direction of one electrode, or reverse. Here, in order to obtain white, titanium oxide can also be used as such coloring particles 51. In that case, it is drawn by coloring particles 51 in the direction of electrode 46, and the color (now white here) can come to be seen.

If it becomes the reverse form, it will be drawn by coloring particles 51 in the direction of electrode 46, and, as a result, particles will disappear with dye addition suspension fluid 52.

FIG. 8A and FIG. 8B are diagrams for explaining the principle of operation of the display indication by the electrophoresis microcapsule containing the plural type or coloring particles.

A color different from a lot of electric charge particles 54 of the single color which there is suspension fluid 53 which comes from oil into electrophoresis microcapsule 47 in FIG. 8A, and contains spiropiran and a chelating agent in it, or a comparable quantity of non-electric charge particles 55 are visually distributed in the contrastive color.

Here, let each particle 54 and 55 be titanium oxide (particles for white), and carbon black (particles for black), for example. If bias is applied to electrodes 49 and 46, coloring particles 54 which have an electric charge will move to the direction of electrode 49 (in this case, the color of that particle becomes strong).

Now, it moves to the direction of white or electrode 46 here (in this case, since particles 54 hide after particles 55, the color of particles 55 becomes strong).

Now, the black will be explained. In this embodiment, although each particle 54 and 55 is made into titanium oxide (particles for white), and carbon black (particles for black), it may put in spiropiran and a chelating agent into electric charge particles 54 or non-electric charge particles 55, for example.

FIG. 8B shows another method. As shown in FIG. 8B, if particles 54 and it make particles 56 made into another color support a reverse electric charge, the push pull effect can be born, and they can increase the visibility of the particles drawn to electrode 49, and can prevent the visual disturbance by the particles by the side of reverse.

When making the group of different particles from another method, although it is an electric charge of the same sign, the size of the electric charge can also be changed by it.

In all these embodiments, there is a difference in the electrophoresis volatility of particles 54 and particles 56 substantially.

In using the term “there is a difference substantially” on these specifications, it means that a desirable electrophoresis action the same as that of the particles of the color of another side or similar is shown only less than about 5% less than about 25% of the particles of one color.

Although the organic EL display, the liquid crystal display, and the electrophoresis type display are explained in full detail in the above explanation, the electronic display unit applied to the multifunction display device of the invention. Not the thing limited to these but in addition to these, a particulate material orientation type display,

A coloring particle rotation type display, a PLZT display, a DMD (digital micro mirror device) display, an electro-granular fluid display, an SED (surface-conduction emitter display), etc. are applicable.

In short, the point of the invention establishes the plurality of kinds of electronic display units, and uses them properly according to a use, and there is. Using the existing flexible plastic material, it is considered as the existing flexible display, and the completed electronic display unit itself shall be flexible to the board member which constitutes these electronic display units, a protect member, etc., and it shall be easy to treat it to them, as well as the non-electronic display unit.

Next, while being an example of representation of the non-electronic display unit applied suitably for the multifunction display device of the invention, the more desirable paper as a non-electronic display unit of the invention will be explained.

Although the paper has flexibility and tends to carry out page turning over etc. needless to say that it is easy to adapt itself to a hand, the paper which is easier to treat is examined here.

The paper suitable for the invention is processed from a plant, and plant tissue is once made scattering. As directivity (anisotropy) of cell fiber structure which the plant originally has by the growth process is made random, and the aggregate of a fiber has isotropic character, while it makes it a sheet-like, the density of a material shall be made to be 0.50 g/cm3 or more.

The density as used in the surface is density generally applied in the paper manufacture industry, and weighing (weight per m2 (the number of grams)) is divided and computed by thickness (it is not strictly the same as the density as used in the physical surface).

This considers synthetically the strength (rigidity) of the elasticity in consideration of the ease of carrying out of page turning over at the time of doing the writing nature (for example, thing which is not permeated to the perviousness or the back of writing ink) as the inspection nature and the writing unit as a display body, and those work etc., and is decided.

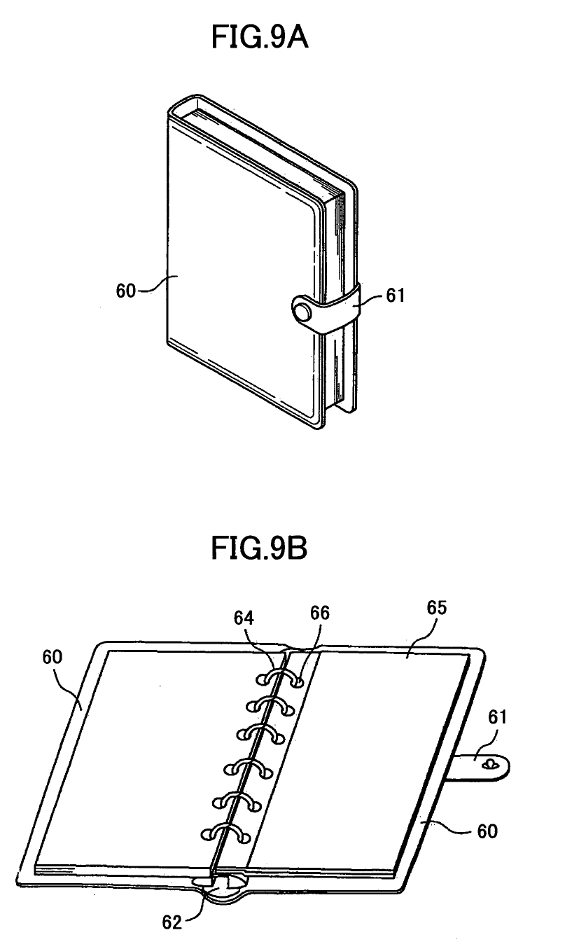

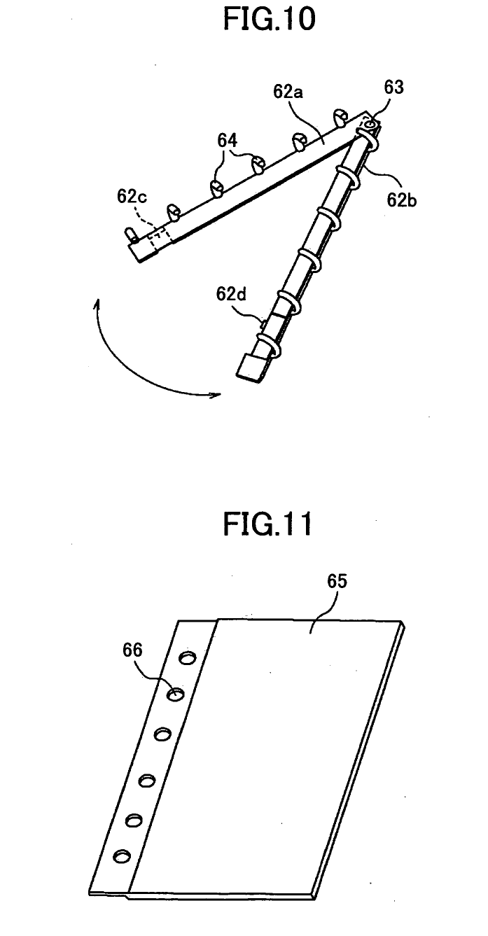

The nine kinds of paper shown in Table 1 are formed as shown in FIG. 11, and they are made into form which is stopped by binder 62 shown in FIG. 9B, it prepared them ten sheets at a time, respectively, and the invention estimated the ease of using.

As a result, the thing of sample No. 7, and 8 and 9 had weak mechanical strength (elasticity), and when carrying out page turning over, it turned out that it is what it is related and cannot use easily attaching.

When strongly written down with the ball-point, the modification (float of a character) by press appeared in the back, the line of the character by the press is further reflected to the paper under it, and it also turned out that they are not desirable.

When it wrote down with a fountain pen in such papers, it also turned out that ink permeates and is not desirable to the extent that it is visible clearly also from the back.

On the other hand, the other sample is what elasticity is also strong, and does not have a float of the character to the back, either, and is very much easy to use it.

It is a grade which also looks at osmosis of ink from the back side, and it does not worry at all. That is, when the plurality of sheets of paper as the non-electronic display unit are used having bundled them, in consideration of note nature, such as strength of a certain amount of elasticity, and ink, etc., it is confirmed that the density of paper must be 0.50 g/cm3 or more.

TABLE 1

| Sample No. | Paper Type | Density |
|---|---|---|
| 1 | glassine paper | 1.10 g/cm3 |
| 2 | India paper | 0.80 g/cm3 |
| 3 | PPC paper | 0.78 g/cm3 |
| 4 | rice paper | 0.62 g/cm3 |
| 5 | newspaper | 0.57 g/cm3 |
| 6 | saturating paper no. 1 | 0.50 g/cm3 |
| 7 | saturating paper no. 2 | 0.41 g/cm3 |
| 8 | Japanese paper no. 1 | 0.32 g/cm3 |
| 9 | Japanese paper no. 2 | 0.20 g/cm3 |

What is called a synthetic paper chemically made from fossil fuels, such as oil, coal, and a natural gas, as an example of other papers can also be conveniently used as a non-electronic display unit of the invention. Plastic sheets, such as an OHP sheet, etc. can be used similarly. These as well as the above-mentioned paper have flexibility, and page turning over etc. tends to carry out them that it is easy to adapt itself to a hand.

The postscript of the information by various writing media, such as a pencil, a ball-point pen, a fountain pen, and a felt-tipped marker, is possible for these non-electronic display units on the surface, and it has not only the display function after a postscript but the memory function of carrying out record preservation of it.

Since these non-electronic display units are easy structure and can be thinly done at a sheet-like compared with an electronic display unit including other non-electronic display units expressed below, they can give the function of a display or a postscript (record preservation) to both-sides both sides of a sheet.

That is, since structure is easy, those functions can be given to both-sides both sides, and presenting of the information or the function of a postscript (record preservation) can be improved twice easily.

And since page turning over is easy for such a non-electronic display unit, even if it gives the function to both-sides both sides of a sheet, un-arranging can double capability in any way on handling, without producing.

Although various kinds of the above-mentioned electron/non-electronic display units are raised as an example applicable suitably for the multifunction display device of the invention, it cannot be overemphasized that the invention is not what is limited only to these display units.

For example, as a different non-electronic display unit, i.e., a display unit which uses electric control and displays an image by using a different control, such as heat or light control, a rewritable paper is applicable. This applies material which will be explained below as a record layer, for example on support media, such as paper and a resin film, by thermal energy control, gives reversibility to coloring and discoloring. Namely, the non-electronic display unit in this case is provided to perform display indication and erasing in a reversible manner.

There are a transparent nebula type rewritable marking method and the coloring/discoloring type rewritable marking method using leuco dye, and all can be recorded by thermal energy control using a thermal head for a heat recording mode.

The transparent nebula type is what distributed the particulates of fatty acid in the macromolecule thin film, and if it heats at 110 degrees C. or more, resin will expand by melting of fatty acid.

Then, if it cools, fatty acid will be in a supercooling state, and will exist with a liquid, and the resin which expanded will solidify it.

Then, fatty acid carries out solidification contraction, it becomes the particulates of polycrystalline, and void is born between resin and particulates. Lights are scattered about according to this void and it looks white.

Next, if it heats in the erasing temperature range of 80 to 110 degrees C., some fatty acid is fused, thermal expansion of the resin will be carried out and it will bury void. If it cools in this state, it will be in a transparent state and elimination of a picture will be performed.

The rewritable marking method using leuco dye uses reversible coloring and the discharge reaction of the colorless charge of leuco printing, and the developing/discoloring agent which has a long chain alkyl group. If heated by a thermal head, leuco dye and the developing/discoloring agent will react and color, and a developing state will be held if it quenches as it is.

Shortly, after heating, if it cools slowly, phase separation will happen by self-condensation action of the long chain alkyl group of the developing/discoloring agent, it dissociates physically and leuco dye and the developing/discoloring agent decolorize.

Otherwise, reversibility is given to coloring by controlling the light energy of a laser beam etc., and the non-electronic display unit in such a case is provided to perform display indication and erasing in a reversible manner.

For example, the photochromic compound which will color to C (cyan) if ultraviolet light is applied, and is decolorized with the light of R (red) of visible light, the photochromic compound which will color to M (magenta) if ultraviolet light is applied, and is decolorized with the light of G (green) of visible light, it is what is called color rewritable paper that provided the photochromic compound which will color to Y (yellow) if ultraviolet light is applied, and is decolorized with the light of B (blue) of visible light on support media, such as paper and a resin film.

This rewritable paper applies ultraviolet light, once makes it deep-black, it is time to apply the light of R-G-B, and strength, and controls the coloring density of three kinds of materials which color to Y-M-C, and expresses the full color.

Temporarily, if it continues applying a powerful light of R-G-B, all three kinds can be decolorized and it can also be made pure white.

What gives reversibility to coloring by such light energy control is suitably applied as a non-electronic display unit of the invention.

The non-electronic display unit applied to the multifunction display device of the invention is not limited to these, and, in short, the plurality of kinds of non-electronic display units are formed, and it uses properly according to uses (picture formation, elimination, etc. by a color/monochrome display, postscript propriety, handwriting retouch/thermal head, or a laser unit).

The amount of display screen is far easy composition compared with an electronic display unit, and since all can be made into thickness almost equivalent to what is called paper or it, and lightness, such a non-electronic display unit can be made thinner in thickness than an electronic display unit, and can make them lightweight.

These non-electronic display units have flexibility, and tend to carry out page turning over etc. that it is easy to adapt itself to a hand.

Since it is light and such a non-electronic display unit has the ease of treating, such as page turning over, almost like paper thinly like paper, it is effective to use the plurality of sheets, bundling.

Specifically, it is good to, use two sheets—about 200 sheets for example, bundling.

Next, the composition of an embodiment of the multifunction display device of the invention in which the display units are combined will be explained using FIG. 9A, FIG. 9B, FIG. 10, and FIG. 11. However, the present invention is not limited to the illustrated embodiment in these figures.

FIG. 9A is a perspective view of the multifunction display device of this embodiment when closed, and FIG. 9B is a perspective view of the multifunction display device of this embodiment when opened.

As shown, the multifunction display device comprises the external cover 60 and the cover fastener 61, and is constituted in the shape of a book. The external cover 60 is arranged so that the plurality of display units 65 are held from the outside.

In the opened state of FIG. 9B, the fastener 61 is unlocked and the inside of the multifunction display device is opened like a book, but the display units 65 are still held with the binder 62.

The display units 65 of the invention comprise the display unit of the organic electroluminescence which displays a color image or a motion picture as described above, the liquid crystal display unit which displays a monochrome image or a still picture, the display unit using electrophoresis particles, the paper which is the traditional non-electronic display unit, etc. which are stacked. The plurality of display units 65 including such electronic display units and the non-electronic display units (paper, etc.) are held with the binder 62 (refer to FIG. 10).

The paper which is the non-electronic display unit can be used therein like a notebook, and it can also be called the writing medium.

Combination of the display units which display a color/monochrome image and a motion/still picture is not limited to the above-mentioned combination, and which display units should be used depends on the user' choice. The display units are not limited to the above-mentioned display units, and the above-mentioned display units and other display units may be combined suitably.

FIG. 11 is a diagram showing a display unit applied to the multifunction display device of the invention, in order to explain how to hold the electronic display units and the non-electronic display units, such as paper.

As described above, the display units 65 in the multifunction display device of the invention comprise a suitable combination of the display units including the electronic display units, such as an organic EL display, a liquid crystal display, an electrophoresis display, and the non-electronic display units such as paper or rewritable paper as the writing medium.

The plurality of holes 66 are formed in the display units or the writing medium, and fitting is carried out to it by pin 64 of binder 62. While each of these display units make a part for a mounting part with a holding unit compatible form (form where the plurality of holes 66 are now formed in this example), each display units attachment and detachment or it is supposed that it is exchangeable.

The mixed combination of the electronic display units and the non-electronic display units such as paper can be arranged in the shape of a book, and it is possible to use the desired display units freely, if needed.

By performing attachment and detachment of binder stop part 62c and 62d of binder stop parts centering on rotary part 63, as this binder 62 is shown in FIG. 10. Rotation division can be carried out in the direction of the arrow of the figure, the pin 64 is also divided into binder 62a and binder 62b, and attachment and detachment of display units (or paper) 65 are enabled.

That is, the paper etc. can exchange for new paper what accumulated by note. Not only paper but the above it has come to be also able to simplify an electronic display units and exchanging, when failure etc. arises. It supplements about the case where a non-electronic display unit is exchanged.

Previously, the invention described that it is effective to use the plurality of non-electronic display units, bundling them. In this case, where the plurality of sheets are bundled, package exchange can also be carried out, but it is good more preferably to enable it to exchange one sheet at a time.

Thus, if it sets, since it can remove at a time one non-electronic display unit which added a postscript (note) and became unnecessary, for example, it is convenient.

Next, the electronic display unit of the invention will be described. As mentioned above, an organic EL display, a liquid crystal display, an electrophoresis type display, etc. are used suitably, and with the advanced technology the electronic display unit of the invention is constructed. When the usage is mistaken, there is a possibility that it is damaged.

For example, when bundling and using the plurality of display units in the multifunction display device, it will be in the state where the electronic/non-electronic display units are contacted, and the mutual contact of the display units and rubbing against the display surface will result in a bad influence, a breakage, or the like.

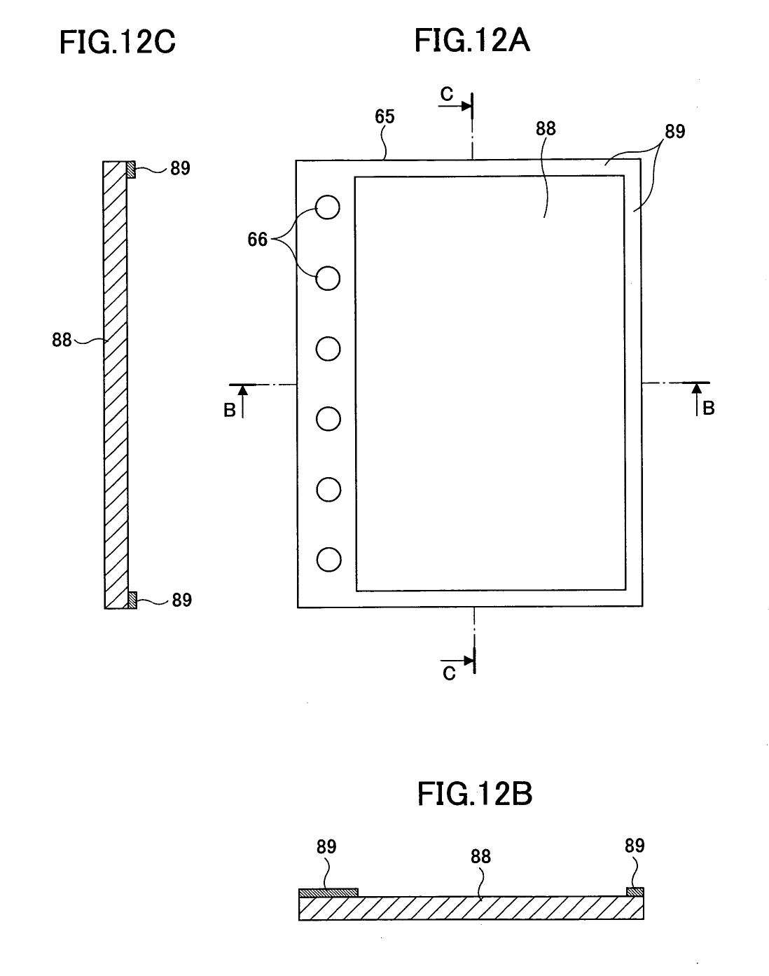

FIG. 12A, FIG. 12B and FIG. 12C show the composition in which the thickness of the peripheral portion is larger than that of the display region in the electronic display unit of the invention. FIG. 12A is a plan view of the electronic display unit, FIG. 12B is a cross-sectional view of the electronic display unit taken along the B-B line in FIG. 12A, and FIG. 12C is a cross-sectional view of the electronic display unit taken along the C-C line in FIG. 12A.

As shown, the position of peripheral portion 89 becomes high and puts in another way about 0.3-5 mm from the surface of display region 88, the thickness of peripheral portion 89 to become thick from display region 88 in the electronic display unit. Such composition can be prepared by providing the frame which becomes a peripheral portion of the display unit 65 from resin etc.

Or the component which comprises resin which constitutes peripheral portion 89 in the glass, or the resin substrate/film plane of translucency which constitutes the display surface of an electronic display unit may be stuck.

Or elastic members, such as rubber/sponge, may be stuck. That is, as the display units of the others which make it like and are laminated by the surface of the display region 88 which becomes thick about the peripheral portion 89 such (it becomes high) does not contact, he is trying to prevent breakage.

As a result, the multifunction display device of the invention does not have breakage of the electronic display unit at the time of use, and is able to be made into the reliable multifunction display device.

Next, the feature of further others of the invention will be explained.

As mentioned above, a mixed combination of the non-electronic display units such as paper and the electronic display units may be used, and a description will be given of the example in which the multifunction display device is provided with an information input unit.

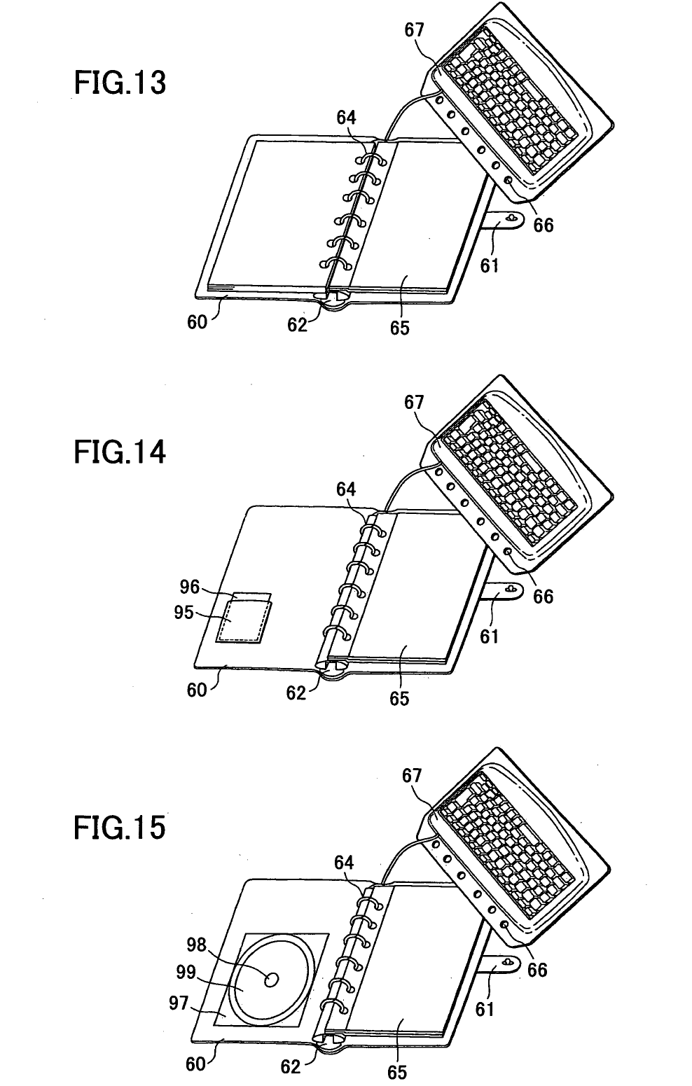

FIG. 13 is a diagram for explaining an example in which the keyboard 67 as the information input unit is attached to the multifunction display device, the plurality of holes 66 are formed in keyboard 67 as well as the display units 65 in this case, and the fitting is carried out by the pins 64 of the binder 62.

And although usually held and carried in the external cover 60 like other display units 65. At the time of use, since it is the composition which enabled attachment and detachment of the form of a terminal area like the display units 65 as compatible, as shown in FIG. 13, it may remove from binder 62, and may be pulled out and used for the outside of the external cover 60. It cannot be overemphasized that it may be used where fitting is carried out by pin 64 of binder 62.

FIG. 13 shows the example which holds keyboard 67 which is an information input unit inside the external cover 60.

And it is the composition best for protecting keyboard 67 which is an information input unit from external force etc., or protecting it from contamination etc.

On the other hand, keyboard 67 which is this information input unit may be formed in the outside of the external cover 60. In that case, in order to protect from breakage, contamination, etc., it is made for each key side to become for inner facing so that it may not become unreserved on the outside.

That is, it has composition that the back side of key arrangement makes the external cover serve a double purpose. Since the back side of key arrangement can make the external cover serve a double purpose if it does in this way, it becomes possible the external cover 60 for which one side is omitted at least.

FIG. 13 shows the example of the keyboard of composition with each three-dimensional key. If it is the whole a keyboard, when the whole keyboard is made into a flexible sheet-like structure, and it also makes each key into touch-sensitiveness, and it used as the key sheet and it combines with the multifunction display device of the invention, user-friendliness, such as the ease of carrying out of a weight saving, portability, and page turning over, improves.

Although a detailed explanation is avoided, the invention provided with such an information input unit also has a computer unit, such as an input/output of information, and operation memory.

Although it is indicated as an information input unit, this information input unit is also presenting of the video information displayed by the display units 65, picture information, alphabetic information, etc., and a unit to process, (edit) memorize and control, and even if it calls it a computer unit in a sense, it does not interfere.

The computer unit (function as a CPU), it is good also as composition which could unite with keyboard 67 shown in FIG. 13, could form, used keyboard 67 only as the keyboard as an input unit, and separated the function as a CPU from keyboard 67 as a unit constituted independently.

This computer unit (or CPU) is suitable as the binder 62 to attachment and detachment being possible like other display units 65, and good also as one composition included in the external cover 60. By the way, electric connection of this computer unit is usually carried out to the display units 65 of the invention (cable connection). The connection can be detached and attached although it is needless to say.

On the other hand, since making this connection by radio does not have layout processing of a connecting cable, either, it is convenient composition.

As other information input unit, a good unit also adopts a touch-panel system and a handwriting stylusoperated unit at the invention. A system with not only a pen-like thing but the human finger may be adopted as the input tool.

The above example is a case where code information inputs, such as a character, are assumed, and it can also apply suitably for the invention a unit to input picture information as bitmap information, as other information input unit.

Specifically, a scanner is applied suitably. In recent years, technology progressed, and a scanner can also take quite thin plate-like composition and can consider it now as the composition which can be detached and attached to the multifunction display device of the invention.

It is also a good method to make the image capture unit represented by a digital camera/digital camcorder into the information input unit applied to the invention.

The motion/still picture information acquired by such an image capture unit are suitably reproduced and displayed by the display units of the invention.

In the case of an image capture unit, it is not necessary to make it into plate-like/sheet-like like other display units, it can be detached and attached to the multifunction display device of the invention, and what is necessary is just to make it.

Next, other features of the invention will be explained. As mentioned above, according to the invention, information is displayed by the display units 65 or controlling the display is performed.

Although a computer unit is needed, the information memory unit (memory or storage) is also provided in connection with this.

The memory or storage may include hard disk (magnetic disk) memories, optical disk memories, such as CD and DVD, blue-ray or magneto-optical disk memories, and semiconductor memories (flash memories).

The drive device for recording or reproducing information in the hard disk memory or optical disk memory may be included in the multifunction display device of the invention.

Even if included in the cover member of a multifunction display device etc. improper attachment and detachment, an optical disc etc. has the feature of portability storage, and can be detached in that case and attached freely.

The USB memory of a semiconductor flash memory etc. is the same. In the case of a hard disk memory, a part for a part for a memory part and a driving part is inseparable, but what is made to a size about 1 inch in diameter like a micro hard disk drive can use the drive device itself conveniently as attachment and detachment and mobility.

The above explanation is raised as an example which uses the memories or storage applied to the invention for control of display indication of the display units of the invention. The composition (holding unit which can detach and attach a storage unit) which include mobility of such memories or storage physically is also one of the features of the invention as simpler composition.

It is possible to specifically establish the pocket structure where storage, such as USB memory card and a memory stick, goes into the cover member of the invention.

FIG. 14 shows the example in which the memory card as the storage is built in the multifunction display device of the invention. In FIG. 14, the storage 96 is shown as the example of memory card and the pocket 95 is formed in the back-side surface of the front cover of the external cover 60.

And it is desirable that the pocket 95 is provided in consideration of the contour and size of the memory card 96 so that the contour and size may be suited.

In the case of the stick-like storage, it is made into the pocket of the thin long form doubled with it although this example shows pocket form 95 suitable for the card size suitable for card-like-shaped storage 96 being stored now. As for this pocket, it is desirable to provide more than one.

Not necessarily that place is not formed in the spread side of the external cover 60, may be formed in the outside portion of a cover like this example, and may be formed in a part for a back cover part.

Or it is good also considering the inside for a back cover part as the storage pocket. The storage domain 97 which FIG. 15 shows the example of storage of other storage, and is formed in the spread side of the external cover 60 and which became a concave (a depth of 1-10 mm) for a while, phi15 mm boss 98 (1-5-mm-high convex part) provided so that it might go into the hole of the central parts, such as CD, DVD, etc. which are formed in the central part, is shown.

The structure 97 of the storage cases, such as CD and DVD, is formed in the spread side of the external cover 60, and it enables it to store the optical disc 99 there.

Although this example is shown as an example which stores the optical disc with the diameter of 120 mm, it is not limited to that size, and if it is a card-like optical disc, it will not necessarily be considered as the storage region 97 according to that form.

The place may also be formed in the outside of the external cover 60. It is more desirable to consider it as the structure where a protective cover is provided all over the so that that may not become by the inside of the external cover 60 and that and such an optical disc may not become unreserved outside.

Next, another feature of the multifunction display device of the invention will be explained.

As described above, the multifunction display device of the invention comprises the electronic display units and the information input unit, and is covered with the external cover 60 (see FIG. 9B and FIG. 13). And it carries and uses it in many cases. In that case, some things for which the multifunction display device of the invention is thrown for carrying out hail at something.

So, in the invention, the outline dimension of the portion equivalent to the cover at the time of opening and closing like the size of the external cover 60, i.e., a book, is made larger than the outline dimension of each the above-mentioned electronic/non-electronic display units, or the information input unit.

That is, the external cover 60 has the dimensions larger than the outside dimensions of the electronic/non-electronic display units or the information input unit, and the electronic/non-electronic display units are arranged in the size of the external cover 60.

The external cover 60 collides before each internal electronic/non-electronic display unit or the information input unit collides, and it is effective in the ability to protect each internal electronic/non-electronic display unit. The external cover 60 is made thicker than the above-mentioned non-electronic display unit.

This is for holding/supporting the weak non-electronic display unit of elasticity good at the time of use (for example, at the time of displaying or writing).

And what is necessary is for the quality of the material to take unexpected accident prevention into consideration, and just to let it be rigid plastic materials, such as polycarbonate resin, ABS resin, and vinyl chloride resin, etc.

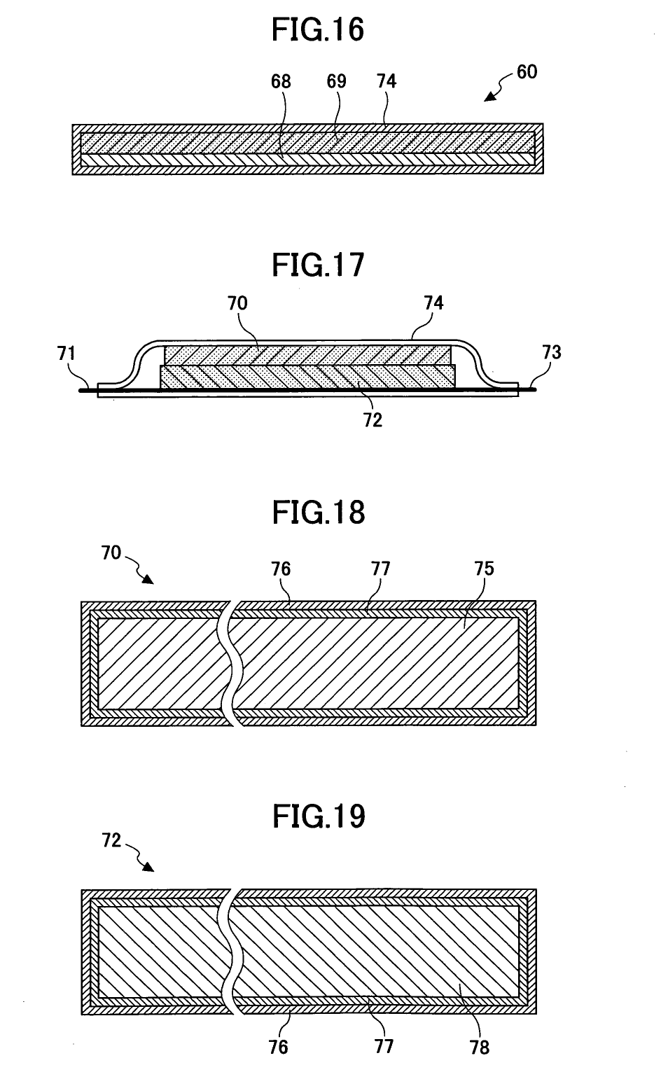

FIG. 16 is a cross-sectional view showing the composition of an example of the external cover in the multifunction display device of the invention.

As shown in FIG. 16, the sheet-like or plate-like external cover 60 is constituted by the supporting substrate 68, the shock absorbing layer 69 and the armor body 74.

The sheet-like and plate-like member which constitute the external cover 60 in this way are made into the lamination sheet-like structure of the plurality of layers, and the invention is made to share a function.

For example, the support substrate 68 has a role which gives rigidity to the external cover 60, and is formed of substrates, such as rigid plastic materials, such as polycarbonate resin, ABS resin, and vinyl chloride resin.

The impact absorbing layer 69 is constituted by the sheet-like sponge member, and when pressure is applied from the exterior or it is shocked, it absorbs them with the elasticity of this sponge member. And breakage of each internal electronic/non-electronic display unit or the information input unit according to a shock is avoidable.

The present invention is not limited to this 2-layer laminated structure, and a multilayer composition from the purpose of ornament is also suitable. Although wrapping with the armor body 74 is not necessarily required, it may constitute from plastic sheeting etc. for waterproofing, or an ornamental meaning may also constitute previously support substrate 68 which makes these two layers, and the laminated material of the shock absorbing layer 69 from a woolen cloth component, a felt component, etc.

Next, other features of the multifunction display device of the invention will be explained.

There are many using carrying like the above-mentioned explanation in the case of the invention. For example, the electronic display units in the external cover 60 will damage with the pressure from the outside if the scene carried puts in and used as a bag etc. is assumed.

Or, as described above, even if it does not put into a bag, when a thing is placed on it, he bears the dignity and the accident in which each electronic/non-electronic display unit or the information input unit is damaged previously can get up.

Then, the composition of the invention protected from mechanical/physical pressure different from the above-mentioned protection unit will be explained.

In the state of FIG. 9A, the multifunction display device is in the closed state like a book. The external cover 60 comprises a front cover and a back cover, and the gap (equivalent to the thickness, as in a book) of the front cover and the back cover is kept below a certain thickness as in the shape of the book.

Specifically, two or more block-like stoppers which define the gap of the front cover and the back cover are disposed on one of the front cover and the back cover, or both, and the block height is to define the gap of the front cover and the back cover.

Although it is needless to say, the height of this block is made into the height more than the total thickness of the display units held in external cover 60.

In addition, when a certain amount of mechanical rigidity is also given to the external cover 60 and physical external force is added according to an unexpected accident, the internal electronic display units are kept from being damaged.

As a material which can give such mechanical rigidity, rigid plastic materials, such as polycarbonate resin, ABS resin, and vinyl chloride resin, can be used.

Namely, a certain amount of rigidity given to the external cover 60 in the invention and the stopper function which is made not to be closed below at the total thickness of the display units when it is closed, the internal electronic display units are protected from the external physical force.

The external cover 60 is constituted like a rigid container as other composition, and it may be made to put the whole aggregate of the display units into the inside of the container. For example, a rigid plastic material, such as polycarbonate resin, ABS resin, or vinyl chloride resin, is sufficient as the material which constitutes such a container.

Next, another feature of the multifunction display device of the invention will be explained.

The external cover 60 of the invention has taken the composition equivalent to the front cover and back cover of a book.

And the display unit or the information input unit is equivalent to the contents of book. The surface which faces the inner part of the external cover 60, i.e., the display units of the external cover 60, an information input unit, etc. is made into the structure which gave elasticity.

Namely, the inner part of the external cover 60 which arranges sheet-like sponge on the inner part of the external cover 60, or allots a woolen cloth component, a felt component, etc., and touches a display units or an information input unit the cartridge in which impact absorption is possible, it is considered as powerful composition or a soft component.

Since a shock is absorbable in the portion by this even if there are some external force and a shock, the accident in which each electronic/non-electronic display unit or the information input unit is damaged is avoidable.

When the external cover 60 is constituted as shown in FIG. 16, the portion of the shock absorbing layer 69 is made into the surface which faces the display units or the information input unit. However, a certain sheet (equivalent to the armor body 74) which does not affect the elasticity and the shock absorbing power may be interposed therein.

Next, another feature of the invention will be explained. As mentioned above, the multifunction display device of the invention includes a mixed group of the electronic display units and the non-electronic display units, such as paper. The composition which supplies electric power to such electronic display units will now be explained.

The multifunction display device of the invention will function to effect the original capabilities (display capabilities or writing function) if the display units 65 which are laminated as mentioned above are held with the binder 62.

However, as shown in FIG. 9B, the display units 65 are held with the binder 62 and covered with the external cover 60.

Although it is for this protecting the content which is an expensive electronic display unit, the above function that protects a content is given to the external cover 60 in the invention.

That is, the function for supplying electric power to the electronic display units is given. Specifically in the invention, it is considered as the battery which considered the external cover 60 as sheet-like composition.

More specifically, a polymer electrolyte battery can use conveniently. Hereafter, one example of the structure will be explained using FIG. 17, FIG. 18 and FIG. 19.

In FIG. 17, the reference numeral 70 denotes a gel polymer electrolyte holding positive electrode unit, and 72 denotes a gel polymer electrolyte holding negative electrode unit.

The above-mentioned gel polymer electrolyte holding positive electrode unit 70. As shown in FIG. 18, after accommodating the positive electrode 75 in the support medium 77 and unifying the positive electrode 75 and the support medium 77, the impregnation of the gelling component content electrolytic solution is carried out, and while glaring ultraviolet rays in the state and polymerizing a monomer component, it is constituted by gelling an electrolytic solution and making it the gel polymer electrolyte 76.

However, FIG. 18 is illustrated as if the gel polymer electrolyte holding positive electrode unit 70 is shown typically and gel polymer electrolyte 76 is formed in the circumference of support medium 77. However, the above-mentioned gelling component content electrolytic solution trespasses upon the inside of the support medium which comprises a porous nonwoven fabric in fact at the time of the impregnation of the gelling component content electrolytic solution to a positive electrode unit, further, it invades also into the hole portion inside a positive electrode, polymerization and gelling are performed there, and it has become a gel polymer electrolyte.

However, since it is hard to illustrate the gel polymer electrolyte of that portion, it is not illustrating in FIG. 18. The gel polymer electrolyte holding negative electrode unit 72.

As shown in FIG. 19, after accommodating the negative electrode 78 in the support medium 77 and unifying the negative electrode 78 and the support medium 77, it is constituted by carrying out impregnation of the gelling component content electrolytic solution, gelling, while polymerizing a monomer component, and considering it as gel polymer electrolyte 76.

It is the same as that of the case where the formation mode of gel polymer electrolyte 76 in this gel polymer electrolyte holding negative electrode unit 72 is also explained in relation to the above-mentioned gel polymer electrolyte holding positive electrode unit 70. And, in FIG. 7, the reference numeral 74 indicates the armor body which is made of the above-mentioned laminate film.

The exterior of the unit cell is constituted so that the above-mentioned gel polymer electrolyte holding positive electrode unit 70 and the gel polymer electrolyte holding negative electrode unit 72 are laminated and such is covered with the armor body 74.

The lead part and positive electrode terminal 71 of positive electrode 75 of the above-mentioned gel polymer electrolyte holding positive electrode unit 70 are connected by welding. The lead part and negative electrode terminal 73 of the negative electrode of gel polymer electrolyte holding negative electrode unit 72 are connected by welding, free one end of positive electrode terminal 71 and free one end of negative electrode terminal 73 are pulled out by the exterior of armor body 74, and the battery is constituted.

Hereafter, a concrete embodiment will be explained. In this example, after wrapping in the nonwoven fabric which also serves as a positive electrode and the negative electrode with a support medium beforehand, unifying the electrode and the support medium and sticking a heat exfoliation sheet on that lead part, impregnation of the gelling component content electrolytic solution is carried out to that each, and it gels and is made a gel polymer electrolyte.

First, it explains from the process which unifies an electrode and a support medium and is used as an electrode unit (that is, unification thing of an electrode and a support medium).

The manufacture of a positive electrode unit is performed as follows. This is cut to the size of 200 mm×320 mm, using a poly-butylene-terephthalate nonwoven fabric (MB1230 (product name) from NKK Co.) with 30 micrometers in thickness, and a basis weight of 12 g/m2 as a support medium.

After sticking a heat exfoliation sheet (Riba-alpha (product name) from NITTO DENKO CO.) on the lead part of the above-mentioned positive electrode, the positive electrode is laid in the portion on the left of the central part of the machine direction of the above-mentioned poly-butylene-terephthalate nonwoven fabric.

After turning up the right-hand side portion and covering a positive electrode, the seal of the side part of the width direction is carried out with the heat anastomosis machine (poly-sealer (product name) from Fuji Impulse Co.), and the poly-butylene-terephthalate nonwoven fabric as a support medium is made, and both are made closed, the positive electrode and the support medium are unified, and it is considered as the positive electrode unit.

The production of a negative electrode unit is performed as follows. After sticking the same heat exfoliation sheet as the case of a positive electrode on the lead part of the above-mentioned negative electrode, accommodated this negative electrode in the same poly-butylene-terephthalate nonwoven fabric as the case of a positive electrode, both are made close, the negative electrode and a support medium are unified, and it is considered as the negative electrode unit.

After immersing the above-mentioned positive electrode unit and the negative electrode unit in the gelling component content electrolytic solution for 1 minute under pressure reduction, respectively and carrying out impregnation of the gelling component content electrolytic solution to a positive electrode unit and a negative electrode unit, each is put into the bag made from polyethylene, and is sealed.

A fusion UV systems Japan black light is used for the next from both sides of polyethylene bag manufacture of above-mentioned entering an electrode unit.

While glaring ultraviolet rays for 8 seconds with the illuminance of 1.2 W/cm2 and polymerizing the monomer component in an electrolytic solution, the electrolytic solution is gelled and it is made the gel polymer electrolyte.

As mentioned above, the positive electrode unit and negative electrode unit which gelled and made the gel polymer electrolyte hold are taken out from a bag.

After removing a heat exfoliation sheet from a lead part by spraying a hot wind (140 degrees C.-160 degrees C.) on the lead part, laminating the above-mentioned gel polymer electrolyte holding positive electrode unit and a gel polymer electrolyte holding negative electrode unit, and it is considered as an unit cell.

The polymer electrolyte battery is produced by carrying out the exterior of it and sealing it by the armor body which comprises a laminate film of the three-layer structure of a polyester film aluminum film denaturation polyolefin film.

Thus, by a polymer electrolyte battery, an electrolyte can be made into a sheet-like and, moreover, production of the battery of a thin form is attained by it at large areas, such as A5-A3 sheet, for example.

The battery using such a polymer electrolyte is excellent in safety and keeping including liquid spill-proof nature.

A thin form battery is made to this polymer electrolyte battery by usually using for an armor body the laminated film made of the aluminum film heart material, constituting the exterior of the unit cell so that the sheet-like thin electrode and the sheet-like polymer electrolyte layer are laminated, and sealing it by the above-mentioned armor body.

It is still thinner, and since it can be considered as the existing flexible material, the battery set by the form of apparatus can be designed.

Therefore, the electronic display units of the invention can be stacked, although it is made the shape of a book, it can apply suitably as the external cover 60, and it can have the composition in which a cover and an electric power supply are combined together.

The battery considered as this sheet-like composition is good also as a sheet-like of one sheet which continued the front cover of a book-like cover, the back cover, and the back cover portion, and good also as a respectively separate independent sheet-like in a front cover, a back cover, and a back cover portion.

It is good also as a sheet-like divided in the smaller domain. By the way, although the battery considered as such sheet-like composition can be considered as a cover etc. and the composition of combination as mentioned above, in the invention, it is not limited to not necessarily making it serve a double purpose.

Since such a battery can take thin sheet-like composition, it is good also as composition which made compatible form a part for a mounting part with appearance form equivalent to the display units 65 of the invention, or a holding unit and whose attachment and detachment are enabled like the display units 65.

Combined with various kinds of the above-mentioned electronic display units is the battery considered as such sheet-like composition, and it is formed in one, i.e., it carries in various kinds of electronic display units, and it is good also as attachment and detachment being possible together with them.

Since various kinds of electronic display units hold a power supply unit individually when it has such composition, even if it removes from the multifunction display device of the invention, it can function as one electronic display unit simple substance.

The power supply unit to these electronic display units is not limited to a sheet polymer battery, and it cannot be overemphasized that it may be a lithium ion battery etc.

Next, another feature of the multifunction display device of the invention will be explained.

The example which uses an organic solar cell for the electronic display units as an example of the solar battery as other composition which supplies electric power will be explained.

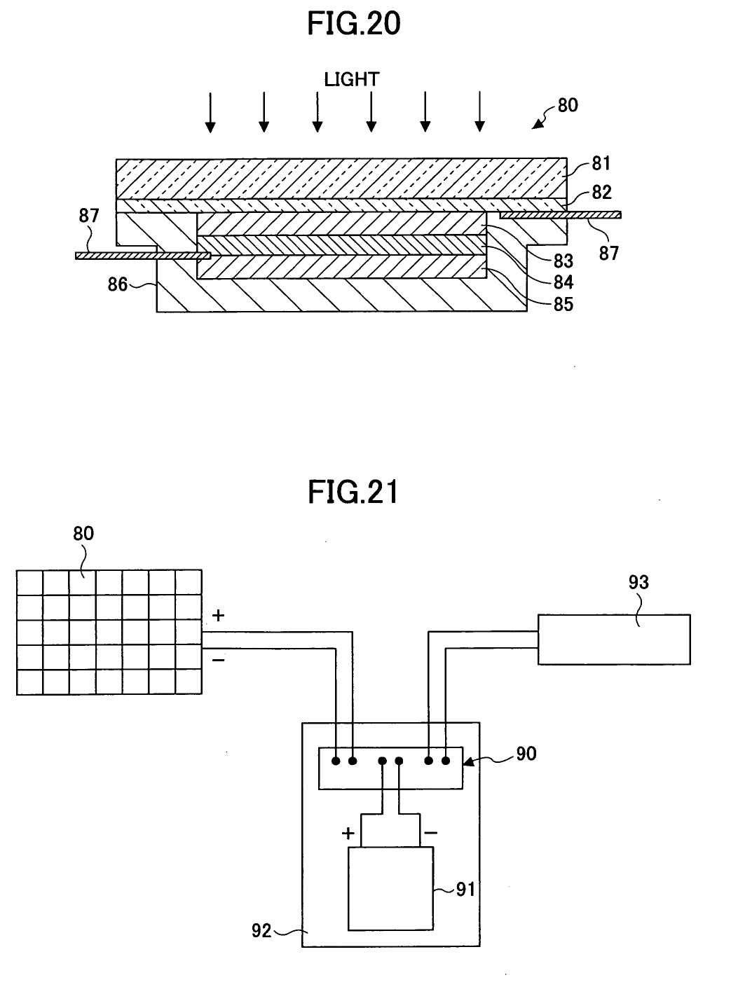

FIG. 20 is a cross-sectional view showing the composition of the organic solar cell which is applied to supply electric power to the electronic display units in the multifunction display device of the invention.

The glass plate or resin film 81, the transparent conductive layer (clear electrode layer) 82, the titanium dioxide colloid power generation layer 83, the platinum paste electrode layer 84, and the flexible reflexibility base material layer 85 are laminated as the component in which the organic solar cell 80 penetrates light from the side into which light enters.

Furthermore, the laminated film 86 for seals from the back side of the flexible reflexibility base material layer 85 in piles, the layered product of the middle class's titanium dioxide colloid power generation layer 83, platinum paste electrode layer 84, and flexible reflexibility base material layer 85 is wrapped in.

While carrying out a heat seal to the lamination side of transparent conductive layer 82 of the glass plate or a resin film in the edge part, it is the composition of having extended electrode leads 87 and 87 outside, respectively from transparent conductive layer (clear electrode layer) 82 and platinum paste electrode 84 used as the counter electrode.

As a manufacturing method of the organic solar cell of such composition, the layered product of the glass plate or resin sheet 81 and the transparent conductive layer 82, the layered product which carried out sputtering of the tin oxide (SnO2) layer to the glass plate or the ETFE resin sheet, and formed the thin film layer is produced, if needed, by laser beam irradiation, the circumference is removed in a desired size and two layers of the SnO is patterned after it.

And apart from the above, aluminum foil is made into the flexible reflexibility base material layer 85 for the layered product of the middle class's titanium dioxide colloid power generation layer 83, the platinum paste electrode layer 84, and the flexible reflexibility base material layer 85, for example.

By using a photogravure reverse roll coater, it applies and dries one by one on it, and platinum paste electrode layer 84 and titanium dioxide colloid power generation layer 83 are produced.

Next, after the above-mentioned middle class's layered product is immersed in the alcoholic liquid which distributed the dye sensitizing agent, for example, a ruthenium catalyst, while drying, and making a titanium dioxide colloid power generation layer support a ruthenium catalyst and making the aluminum foil layer of the layered product puncture ostium at the predetermined gap.

If needed, it cuts into the size of two layers of the patterned SnO(s), and it piles up and the titanium dioxide colloid power generation on the layer surface heats so that the two layers of SnO(s) side which the glass plate or the ETFE resin sheet patterned may be touched (heat treatment).

At this time, electrode lead 87 can be processed into two layers of electrodes of both sides, i.e., SnO, and platinum paste electrode layers, and both end face part can be joined with adhesives in the shape of spot.

Subsequently, the laminated film for seals prepared independently, the back, i.e., aluminum foil layer surface, of the above-mentioned layered product, for example, the middle class's layered product is wrapped in for the laminated film of PET film/aluminum foil/PET film/ethylene vinyl acetate copolymerization resin layer (sealant layer) in piles.

The organic solar cell 80 can be manufactured by carrying out the seal of the circumference to the glass plate or ETFE resin sheet side.

Thus, since manufactured organic solar cell 80 is a sheet-like or plate-like composition, it can realize the multifunction display device which has a power supply unit by using this organic solar cell 80 instead of the external cover 60 of FIG. 9A through FIG. 13.

FIG. 21 is a diagram showing the composition of the storage battery and the organic solar cell which supplies electric power to the electronic display units of the invention. It is constituted by the organic solar cell 80, the storage battery unit 92, and the electronic display units 93.

There are the storage battery 91 and the control unit 90 in the storage battery unit 92. Electric power is charged by power generation of the organic solar cell 80 with solar natural light or a solar fluorescent light of daytime etc. at the storage battery 91, electric power is taken out from there, and the electronic display units 93 are supplied.

The capacity of storage battery 91 is selected that the day when charge of the storage battery 91 by the organic solar cell 80 cannot be performed in bad weather seems to continue for several days.

Although the above explanation raised with the roll coater the example of the organic solar cell which can be manufactured to a large area as a solar battery. When generation efficiency (energy conversion efficiency) is given priority to and considered, it is good to use the amorphous-silicon solar cell (energy conversion efficiency: about 7%) manufactured by sputtering.

In this solar battery, the present generation efficiency taking into consideration (7% or less), it is preferred to have the largest possible area composition.

For example, a good idea also constitutes the whole surface of the external cover 60 from this solar battery. On the other hand, it may be made to form this solar battery in the external cover 60 from the restrictions on a design.

The battery as well as the above-mentioned polymer battery since such a solar battery can also be considered as sheet-like composition or plate-like composition. It cannot be overemphasized that it is good also as composition which made compatible form a part for a mounting part with appearance form equivalent to the display units 65 or the holding unit and whose attachment and detachment are enabled like the display units 65.

Otherwise, not all electric power is provided with the organic solar cell 80. The good method could be made to carry out an electric power supply also from AC100V power supply of home use combining with fuel cells, such as above polymer batteries, lithium ion batteries, etc., namely, also considers it what is called as the electric power supply system of the hybrid composition which has the plurality of kinds of sources of an electric power supply.

Also in a situation which does not have electric power supply capability with a sufficient solar battery temporarily by that cause, for example, the situation of the prolonged use in a gloomy place, it can complement by a polymer battery's performing an electric power supply, or performing an electric power supply from a fuel cell, and can be used comfortably.

The desirable embodiment of the multifunction display device of the invention positioned as mobile computing devices also has composition which may use AC100V power supply for home use, and can be used in response to supply of DC 12V or DC24V from the battery of a car depending on the case.

It is a display unit held which holds and laminates the electronic/non-electronic display units, the display units in which the motion/still picture displays are possible, and the display units in which the color/monochrome displays are possible in the invention so that more clearly than the above explanation.

And when you need a color display, a monochrome display is enough and you need a motion picture display, respectively, and a still picture display is enough.

There is an advantage that it is effectively utilizable according to the characteristics as the display units of the display units or writing according to the use of the case where writing is needed, and the information after the writing.

The present invention is not limited to the above-described embodiments, and variations and modifications may be made without departing from the scope of the present invention.

Further, the present application is based on and claims the benefit of priority of Japanese patent application No. 2004-224613, filed on Jul. 30, 2004, Japanese patent application No. 2005-017766, filed on Jan. 26, 2005, Japanese patent application No. 2005-019754, filed on Jan. 27, 2005, Japanese patent application No. 2005-019924, filed on Jan. 27, 2005, Japanese patent application No. 2005-020128, filed on Jan. 27, 2005, Japanese patent application No. 2005-022394, filed on Jan. 31, 2005, and Japanese patent application No. 2005-022834, filed on Jan. 31, 2005, the entire contents of which are hereby incorporated by reference.

What is claimed is:

1. A multifunction display device comprising:
a plurality of display units having a sheet-like or plate-like configuration and different display capabilities;
a holding unit holding the plurality of display units; and
a power supply unit supplying power to the plurality of display units,
wherein the plurality of display units, the holding unit, and the power supply unit are united, and a display surface of each of the plurality of display units is allowed to be freely opened or closed in a rotatable manner by the holding unit.

2. The multifunction display device according to claim 1 wherein the plurality of display units comprise an electronic display unit and a non-electronic display unit, the non-electronic display unit being smaller in thickness and weight than the electronic display unit.

3. The multifunction display device according to claim 2 wherein one of the electronic display unit and the non-electronic display unit is detachable from the multifunction display device.

4. The multifunction display device according to claim 2 wherein each of the electronic display unit and the non-electronic display unit has a mounting part connected to the holding unit, and the mounting parts of the electronic display unit and the non-electronic display unit are compatible with each other.

5. The multifunction display device according to claim 2 further comprising an information input unit inputting information used to control information which is displayed on the electronic display unit.

6. The multifunction display device according to claim 5 wherein the information input unit is detachable from the multifunction display device.

7. The multifunction display device according to claim 5 wherein the information input unit is a keyboard unit.

8. The multifunction display device according to claim 5 wherein the information input unit is a stylusoperated unit.

9. The multifunction display device according to claim 5 wherein the information input unit is a scanner unit.

10. The multifunction display device according to claim 5 wherein the information input unit is an image capture unit.

11. The multifunction display device according to claim 1 further comprising a storage unit which is detachably attached to the multifunction display device.

12. The multifunction display device according to claim 1 wherein at least one of the plurality of display units has a flexibility.

13. The multifunction display device according to claim 2 wherein the electronic display unit is provided to display a motion picture.

14. The multifunction display device according to claim 2 wherein the electronic display unit is provided to display a color image.

15. The multifunction display device according to claim 2 wherein the non-electronic display unit is provided to perform display indication and erasing in a reversible manner.

16. The multifunction display device according to claim 15 wherein the display indication and erasing is performed in the reversible manner by controlling a thermal energy supplied to a display surface of the non-electronic display unit.

17. The multifunction display device according to claim 15 wherein the display indication and erasing is performed in the reversible manner by controlling a light energy supplied to a display surface of the non-electronic display unit.

18. The multifunction display device according to claim 2 wherein the non-electronic display unit is a paper having a density of 0.50 g/cm3 or more.

19. The multifunction display device according to claim 1 further comprising:
an information input unit inputting information used to control information which is displayed on an electronic display unit among the plurality of display units; and
a cover member disposed to hold an outside of the multifunction display device and having a sheet-like or plate-like configuration and a surface which is freely opened or closed in a rotatable manner,
wherein the plurality of display units and the information input unit are stacked, and the cover member has outside dimensions larger than dimensions of the plurality of display units and the information input unit.

20. The multifunction display device according to claim 19 wherein the cover member is larger in thickness than a non-electronic display unit among the plurality of display units, and formed integrally with the holding unit.

21. The multifunction display device according to claim 19 wherein the cover member has a laminated sheet structure of a plurality of layers containing a shock absorbing layer.

22. The multifunction display device according to claim 19 wherein the cover member has a rigidity larger than a rigidity of the plurality of display units.

23. The multifunction display device according to claim 19 further comprising a thickness maintaining unit maintaining a thickness of a region where the plurality of display units are held by the cover member.

24. The multifunction display device according to claim 19 wherein the cover member is provided to have a shock-absorbing surface which faces the plurality of display units or the information input unit.

25. The multifunction display device according to claim 2 wherein the cover member is provided to serve as the power supply unit which supplies power to the electronic display unit.

26. The multifunction display device according to claim 25 wherein the cover member is made from a sheet polymer battery.

27. The multifunction display device according to claim 25 wherein the cover member is made from a solar battery.

28. The multifunction display device according to claim 27 further comprising a secondary cell which stores electric power generated by the solar battery.
